(19) United States
(12) Patent Application Publication
(10) Pub. No.: US 2010/0332509 A1
(43) Pub. Date: Dec. 30, 2010

(54) SYSTEMS AND METHODS FOR INTEGRATED MANAGEMENT OF GOVERNMENTAL PROJECTS

(76) Inventors: Gary Thomas Rogers, Fairfax Station, VA (US); James Nelson Deprado, Leesburg, VA (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/495,499

(22) Filed: Jun. 30, 2009

(51) Int. Cl. G06F 17/30; G06F 7/00; H04L 9/32

(52) U.S. Cl. 707/759; 726/3; 707/769; 707/783; 707/802; 707/803; 707/770; 707/812

(57) ABSTRACT

A program management (PM) application can provide a universal and secure interface for users to enter data for governmental projects, manage and consolidate the data according to governmental contacting rules, and generate a variety of reports as required by the governmental contracting rules. The PM application can utilize customized and customizable forms that allow the user to enter data for governmental projects. The forms can be generated as graphical user interfaces (GUIs) that allow the user to select different types of data to enter into the PM application. The PM application can classify and store the received data in a program management (PM) database. The PM application can classify the data in a hierarchical structure as required by the rules of governmental contracting.

### FIELD

This invention relates generally to program management. In particular, the invention relates to systems and methods for integrated program management for governmental programs and projects.

### BACKGROUND

Governmental support by private industries plays a large role in today's economy. Most governmental branches and agencies lack the ability to fully support all the services and functions provided by the branches and agencies. To adequately service the public, the government contracts with private entities, such as individuals, businesses, partnerships, companies, corporations, etc., to assist in providing the services and functions provided by the government. For example, the Department of the Defense (DOD) contracts with private entities to provide logistic support for military operations, the Federal Emergency Management Agency (FEMA) contracts with private entities to provide humanitarian aid during natural disasters, the Office of Personal Management (OPM) contracts with private entities to provide human resources services for governmental employees, and the like.

In order to ensure that the public is adequately served and tax-payer money is properly utilized, the government maintains a set of rules for any entity contracting with the government. These rules require that the governmental contractor maintain detailed and accurate records of the services provided to governmental agencies and branches. These records include all information related to the projects performed such as details of the projects, personnel working on the project, governmental money spend on the project, work performed by personnel, and the like. Additionally, these rules require that the governmental contractors periodically or on-demand provide detailed reports outlining and describing the work and services performed by the governmental contractor, such as reports of money spent, hours worked, progress on the project, etc. If the governmental contractors fail to comply with these rules, the governmental contractors run the risk of a contract being suspended or revoked.

Due to the governmental contracting rules, the governmental contractors devote a significant amount of internal resources complying with the governmental contracting rules. Often, the governmental contractors task different employees with the responsibility of capturing, categorizing and maintaining the information associated with projects, and retrieving, analyzing and organizing the information in order to generate the reports as required by the governmental contracting rules. For example, accounting employees may be responsible for tracking hours worked, human resources (HR) employees may be responsible for tracking money spent, managers may be responsible for generating program and status reports for the governmental agency, etc. Typically, the different employees tasked with different responsibilities utilize different tools for capturing, categorizing and maintaining the information and different tools for generating the reports. For example, the accounting employees may utilize a financial program such as QuickBooks by INTUIT to track money spent, the HR employees may utilize a database program such as Access by MICROSOFT Corporation to track hours worked, and the managers may utilize spreadsheet programs such as Excel by MICROSOFT Corporation to generate various other reports.

In order to meet the governmental contracting rules, the different employees must share and exchange the information for which each is responsible. Due to the different tools utilized, however, the sharing and exchanging of the information can consume a significant amount of the employees' time. Often, the different tools maintain the information in different formats, and the data must be converted and reentered into the different tools. For example, to generate reports, the managers must collect the information maintained by the accounting and HR employees. Because these employees utilize different programs, the accounting and HR employees must provide the information to the managers in a format usable by the managers, for example, by printing the information. Then, the managers must re-enter the data in the spreadsheet programs in order to generate reports as required by the governmental contracting rules.

Because the governmental contractors do not have a unified and integrated way to manage the information associated with governmental contracts, the governmental contractors expend significant time and resources managing the information for different projects according to the governmental contracting rules. As such, the cost of services for governmental projects increases for the governmental contractors, and, by implication, the cost increases for the government and tax-payer. Likewise, because the information is maintained in a variety of different tools and formats, the governmental contractors lack the ability to view the overall picture of the governmental projects which they are servicing.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is block diagram of an exemplary environment in which a program management (PM) application can be utilized to manage a governmental project as required by governmental contracting rules, according to various embodiments;

FIG. 2 is a block diagram of exemplary components of the PM application, according to various embodiments;

FIG. 3 is block diagram of an exemplary data hierarchy utilized by the PM application to classify data in a program management (PM) database, according to various embodiments;

FIG. 4 is a diagram illustrating an exemplary table utilized to store data in the PM database, according to various embodiments;

FIG. 5 is a block diagram of an exemplary computing system, according to various embodiments;

FIGS. 6-17 are diagrams of exemplary graphical user interfaces generated by the PM application, according to various embodiments;

FIGS. 18-23 are diagrams of exemplary reports generated by the PM application, according to various embodiments; and

FIGS. 24-25 are flow diagrams of exemplary processes performed by the PM application, according to various embodiments.

### DETAILED DESCRIPTION

For simplicity and illustrative purposes, the principles of the present teachings are described by referring mainly to exemplary embodiments thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific exemplary embodiments. Electrical, mechanical, logical and structural changes may be made to the exemplary embodiments without departing from the spirit and scope of the present teachings. The following detailed description is, therefore, not to be taken in a limiting sense and the scope of the present teachings is defined by the appended claims and their equivalents.

Embodiments of the present teachings relate to systems and methods for integrating various aspects of program management for governmental programs and projects. More particularly, a program management (PM) application provides a unified and integrated platform for managing all aspects of data entry, data management, security, and reporting for governmental programs and projects according to governmental contracting rules.

According to embodiments, the PM application can be configured to provide a universal and secure interface for users to enter data for governmental projects, manage and consolidate the data according to governmental contacting rules, and generate a variety of reports as required by the governmental contracting rules. The PM application can be configured to utilize customized forms that allow the user to enter data for governmental projects. The forms can be generated as graphical user interfaces (GUIs) that allow the user to select different types of data to enter into the PM application. The PM application can generate the GUIs in any type of format that is accessed directly from interacting with the PM application or that is accessed remotely via other programs such as a web browser. The PM application can also be configured to receive access information from the user via the GUIs and authenticate the users based on the received access information. The PM application can also limit access to enter and modify data based on the received access information.

According to embodiments, the PM application can be configured to classify and store the received data in a program management (PM) database. The PM application can classify the data in a hierarchical structure as required by the rules of governmental contracting. For example, the PM application can classify the data based on unique identifiers, such an identifier of the governmental project and identification of employees, and a work breakdown associated with each unique identifier. Under each work breakdown, the PM application can classify the data according to topics associated with each work breakdown such as deliverables, metrics, staffing, risks, and monthly reports. The PM application can store the classified data in tables in the PM database for each topic associated with the unique identifiers and the work breakdown.

According to embodiments, the PM application can be configured to receive requests for the classified data stored in the PM database. Once received, the PM application can search the PM database for the classified data that matches the received request. Once located, the PM application can provide the matching data to the requester. The PM application can provide the matching data in an interface arranged according to the unique identifier, work breakdown, and work breakdown topics.

According to embodiments, the PM application can be configured to generate customizable reports for the classified data stored in the PM database. The PM application can be configured to generate customized reports to include topics selected by the user. For example, the PM application can generate reports for specified unique identifiers, work breakdowns, work breakdown topics, and/or other parameters such as dates, time periods or other data stored in the PM database. Likewise, the PM application can be configured to generate standard reports that are required by the governmental contracting rules.

By providing a unified platform, the PM application allows multiple users, located at any location, to enter data associated with governmental projects, and the PM application stores and maintains the data in a consolidated location and format. As such, the PM application allows any employees of the governmental project to enter and share data without converting and transferring data between disparate applications. Accordingly, the PM application reduces the overhead required to service governmental projects under governmental contracts.

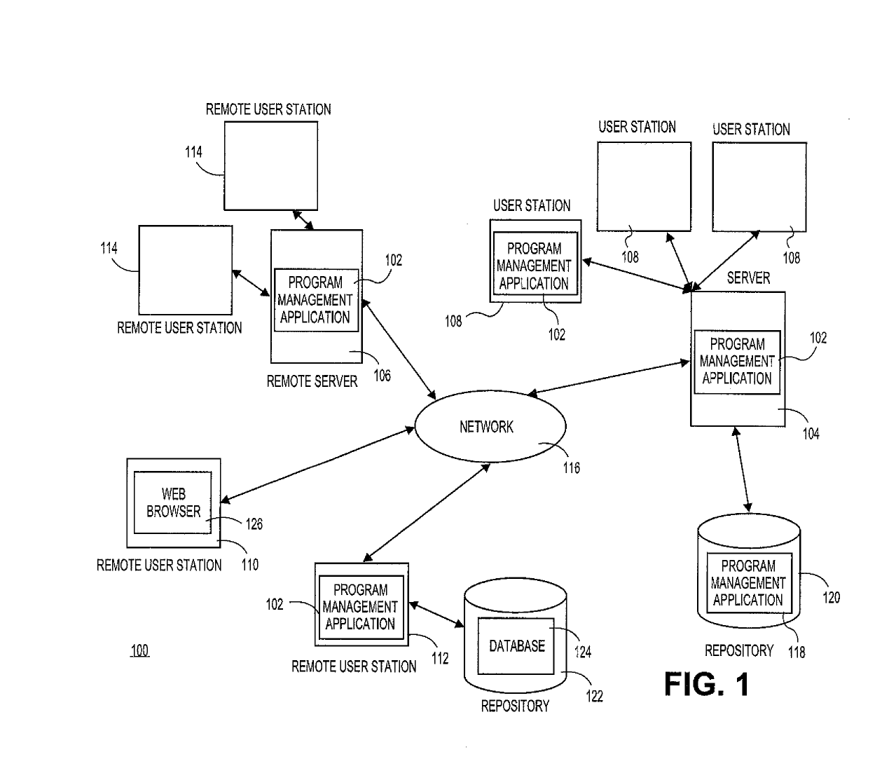

FIG. 1 illustrates an exemplary environment 100 in which a program management (PM) application 102 can be utilized for managing all aspects of data entry, data management, security, and reporting for governmental programs and projects according to governmental contracting rules. While FIG. 1 illustrates various systems contained in the environment 100, one skilled in the art will realize that these systems are exemplary and that the environment 100 can include any number of systems.

As illustrated in FIG. 1, the environment 100 can represent the systems private entities, such as individuals, businesses, partnerships, companies, corporations, etc., utilized to support and service governmental agencies under a governmental contract. The environment 100 can include a number of computing systems, such as server 104, remote server 106, user stations 108, and remote user stations 110, 112 and 114. The computing systems, such as the server 104, remote server 106, user stations 108, and remote user stations 110, 112 and 114, can include hardware resources, such as processors, memory, network hardware, storage devices, and the like, and software resources, such as operating systems (OS), application programs, and the like.

In embodiments, the computing systems in environment 100 can be located at any location, whether located at single geographic location or remotely located from each other. For example, the environment 100 can represent the computing systems of a company which services governmental projects. As such, the server 104 and the user stations 108 can be located a one location (e.g. one office of the company) and the remote server 106 and the remote user stations 110, 112 and 114 can be located at one or more different locations (e.g. satellite offices of the company or the governmental agency). In order to communicate and share data, the server 104, remote server 106, user stations 108, and remote user stations 110, 112 and 114 can be coupled to one or more networks 116. The one or more networks 116 can be any type of communications networks, whether wired or wireless, to allow the computing system to communicate, such as wide-area networks or local-area networks. For example, the server 104 and the user stations 108 can be coupled to a local area network (not shown), and the server 104, remote server 106, user stations 108, and remote user stations 110, 112 and 114 can be coupled to the network 116, such as the Internet or other public or private networks.

In embodiments, to service governmental contracts, one or more of the computing systems can include the PM application 102. The PM application 102 can be configured to provide a universal and secure interface for users to enter data for governmental projects, manage and consolidate the data according to governmental contacting rules, and generate a variety of reports as required by the governmental contracting rules. The PM application 102 can be configured as an application program that is capable of being stored on and executed by the computing systems of the environment 100, such as the server 104, remote server 106, user stations 108, and remote user stations 110, 112 and 114. The PM application 102 can be configured to include the necessary logic, commands, instructions and routines to perform the processes of managing governmental projects as described above and below. As such, the PM application 102 can be written in a variety of programming languages, such as JAVA, C++, Python code, Visual Basic, hypertext markup language (HTML), extensible markup language (XML), and the like to accommodate a variety of operating systems, computing system architectures, etc.

In embodiments, the PM application 102 can be configured to utilize customized forms that allow the user to enter data for governmental projects. As such, the PM application 102 can be configured to include the necessary logic, commands, instructions and routines to generate graphical user interfaces (GUIs) that allow the user to select different types of data to enter into the PM application 102. The PM application 102 can be configured to generate the GUIs in any type of format that is accessed directly from interacting with the PM application 102 or that is accessed remotely via other programs, such as a web browser. The PM application 102 can also be configured to receive access information from the user via the GUIs and authenticate the users based on the received access information. The PM application 102 can also limit access to enter and modify data based on the received access information.

In embodiments, the PM application 102 can be configured to classify and store the received data in a program management (PM) database 118. The PM application 102 can be configured to classify and store the data in a hierarchical structure as required by the rules of governmental contracting. Once classified, the PM application 102 can be configured to store the classified data in the PM database 118. The PM database 118 can be configured according to any type of proprietary or open-source database format or scheme. The PM database 118 can be stored in a repository 120 that is accessible to the server 104, remote server 106, user stations 108, and remote user stations 110, 112 and 114 executing the PM application 102. The repository 120 can be any type of computer readable storage medium, such as hard drives, optical storage, and the like.

In embodiments, the PM application 102 can be configured to classify and store the data, in the PM database 118, utilizing tables associated with identifiers and topics related to the rules of governmental contracting. For example, the PM application 102 can classify the data based on a unique identifier of the governmental project and a work breakdown associated with each unique identifier. Under each work breakdown, the PM application 102 can classify the data according to topics associated with each work breakdown such as deliverables, metrics, staffing, risks, and monthly reports. The PM application 102 stores the classified data in tables in the PM database 118 for each topic associated with the unique identifier and the work breakdown. Likewise, for example, the PM application 102 can classify the data based on other identifiers, such as employees of the governmental contractors. Under each work breakdown for employees, the PM application 102 can classify the data according to topics associated with each work breakdown such as deliverables, metrics, work performed, risks, and monthly reports.

In embodiments, the PM application 102 can be configured to receive requests for the classified data stored in the PM database 118. Once received, the PM application 102 can be configured to search the PM database 118 for the classified data that matches the received request. As such, the PM application 102 can be configured to include the necessary logic, commands, instructions and routines to search the PM database 118 utilizing any type of searching algorithms or schemes. Once located, the PM application 102 can be configured to provide the matching data to the requestor. As such, the PM application 102 can be configured to include the necessary logic, commands, instructions and routines to generate GUIs to provide or display the matching data to the requester. The PM application 102 can provide the matching data in an interface arranged according to the unique identifiers, work breakdown, and work breakdown topics.

In embodiments, the PM application 102 can be configured to generate customizable reports for the classified data stored in the PM database 118. The PM application 102 can be configured to generate customized reports to include topics selected by the user. For example, the PM application 102 can generate reports for specified unique identifiers, work breakdowns, work breakdown topics, and/or other parameters such as dates, time periods or other data stored in the PM database 118. Likewise, the PM application 102 can be configured to generate standard reports that are required by the governmental contracting rules. As such, the PM application 102 can be configured to maintain set of preconfigured reports and configured to populate the reports with the appropriate information from the PM database 118.

In embodiments, the PM application 102 can be stored on and executed by any number of the computing system in the environment 100. As such, a user situated at any location can enter, manage, and retrieve data from the PM database 118. For example, as illustrated in FIG. 1, the PM application can be stored on and executed by the server 104, the remote server 106, one or more of the user stations 108, and the remote user station 112. For instance, the server 102 can store and execute the PM application 102 and allow one or more of the user stations 108 to access the PM application 102 using a client-server model. Additionally, one or more the user stations 108 can locally store and execute the PM application 102, which can access and communicate with the PM database 118.

In embodiments, additional instances of the PM application 102 can be stored and executed on the computing systems which are remotely located from the PM database 118. For example, the remote server 106 can store and execute another instance of the PM application 102. In this example, the remote server 106 can allow one or more of the remote user stations 114 to access the PM application 102 using a client-server model. Additionally, the PM application 102 can access the PM database 118, via the one or more networks 116, by directly communicating with the PM database 118 or by communicating with the PM application executing on the server 104.

In embodiments, the PM application can be configured to extract data from other types of databases, to classify the data according to the structure of the PM database 118, and to store the data in the PM database 118. For example, the remote user station 112 can locally store and execute the PM application 102. In this example, the PM application 102, executing on remote user station 112, can access the PM database 118 via the one or more networks 116. Additionally, the remote user stations 112 can be coupled to a repository 122 containing a database 124. The database 124 can be associated with various other types of database applications and can store data related to governmental projects. The PM application 102 can be configured to extract data from the database 124, to classify the data according to structure of the PM database 118, and to store the classified data in the PM database 118. To achieve this, the PM application can be configured to include the necessary logic, commands, instructions and routines to communicate with and extract data from the database 124, according to its structure and format, and to classify and store the extracted data according to the data structure of the PM database 118.

In embodiments, the PM application can be configured to interface with other types of application programs to allow user to enter, manage, and extract data from the PM database 118. For example, the remote user station 110 can access the PM application 102 executing on any of the other computing systems, utilizing other types of programs and applications. As mentioned above, the PM application 102 can be configured to generate GUIs, such as web pages, which are accessible via other programs and application, such as a web browser. In this example, the remote user station 110 can store and execute a web browser application 126. The remote user station 110, utilizing the web browser 126, can receive and display GUIs from the PM application 102, for instance, the PM application 102 executing on the server 104, via the network 116.

While FIG. 1 illustrates several computing systems executing the PM application 102 in the environment 100, one skilled in the art will realize that any computing system in the environment 100 can execute the PM application 102. Additionally, while FIG. 1 illustrates the PM database 118 being store in the repository 120, one skilled in the art will realize that PM database 118 can be stored in any computer readable storage medium of the environment 100. Further, while FIG. 1 illustrates one PM database 118 for the environment 100, one skilled in the art will realize that the environment 100 can include any number of PM databases 118. For instance, additional PM databases 118 can be maintained as backups for the PM database 118, and, likewise, multiple PM databases 118 can store different data related to the governmental projects. As such, the PM application 102 can be configured to synchronize and to transfer data between the PM databases 118.

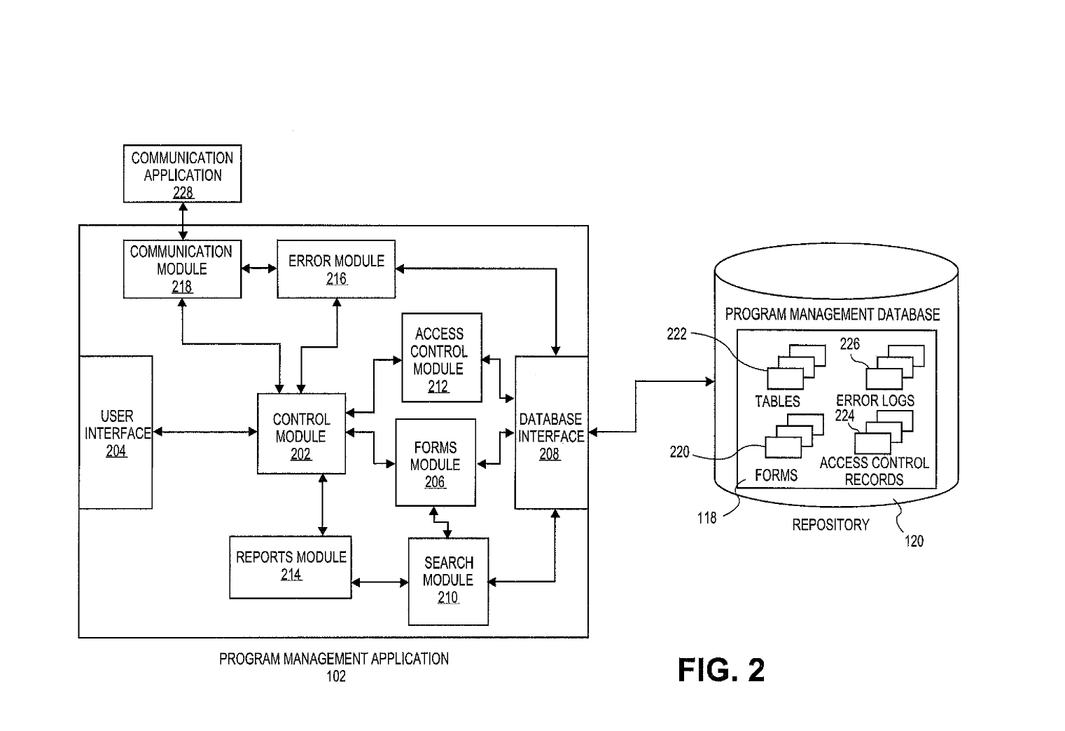

FIG. 2 illustrates exemplary components of the PM application 102 according to various embodiments. The PM application 102 can include various software components to perform the functionality of the PM application 102. The software components can be configured to include the necessary logic, commands, instructions and routines to perform the functionality of the PM application 102. As illustrated, the PM application 102 can be configured to include a control module 202, user interface 204, forms module 206, database interface 208, search module 210, access control module 212, reports module 214, error module 216, and communication module 218. The PM application 102 can be written in a variety of programming languages, such as JAVA, C++, Python code, Visual Basic, HTML, XML, and the like to accommodate a variety of operating systems, computing system architectures, etc. While FIG. 2 illustrates various exemplary components of the PM application 102, one skilled in the art will realize that the PM application 102 can include additional modules to perform the processes described herein.

In embodiments, the control module 202 can be configured to manage and interface with the other modules 204-218 to provide the functionality of the PM application 102 as described above and further described herein below. The control module 202 can be configured to provide the overall control of the other modules 204-218.

In embodiments, the control module 202 can be coupled to the user interface 204. The user interface 204 can be configured to generate GUIs that include controls, fields, widgets, and the like to allow access to and control of the PM application 102. For example, the generated GUIs can include controls, fields, widgets and the like that allow the user to request access to the PM application 102, to enter and store data relating to governmental projects in the PM database 118, to retrieve and view data relating to governmental projects from the PM database 118, to generate and output reports relating as required by governmental contracting rules, and to set and alter access rights of the users to the PM application 102. To generate the GUIs, the user interface 204 can be configured to request forms from the forms module 206. The user interface 204 can be configured to generate the GUIs in a variety of different formats in order to provide the generated GUIs to the user via different outputs. For example, the user interface 204 can be configured to instruct display hardware associated with the computing systems of environment 100 to display the generated GUIs. Likewise, the user interface 204 can be configured to provide the GUIs to other application programs (e.g. web browsers, etc.) upon request.

In embodiments, the forms module 206 can be coupled to the control module 202 and the database interface 208. The forms module 206 can be configured to retrieve one or more forms 220 from the PM database 118 to be utilized by the user interface 204 in generating the GUIs. The forms 220 can be configured as generalized templates that specify the controls, fields, widgets, and the like to be included in the GUIs. The forms 220 can be configured according to the data associated with governmental projects and the structure of the PM database 118. The forms module 206 can be configured to generate queries to retrieve the appropriate forms 220 from the PM database 118 via the database interface 208. The database interface 208 can be configured as an application programming interface (API) to allow the queries to be passed to the PM database 118. The forms module 206 and the database interface 208 can be configured to communicate with the PM database 118 utilizing any type of languages or protocols, such as structured query language (SQL).

In embodiments, the user interface 204 can be configured to generate and provide GUIs to allow the user to perform the functionality of the PM application. For instance, the user interface 204 can be configured to generate GUIs to allow the user to enter data related to governmental projects. When generating the GUIs, the user interface 204 can request the forms 220 associated with data entry from the forms module 206 and can receive the appropriate forms 220 from the forms module 206. Once the GUIs have been provided to the user, the user interface 204 can be configured to receive data input by the user in the GUIs. Once received, the user interface 204 can pass the entered data to the forms module 206, via the control module 202, for classification and storage in the PM database 118.

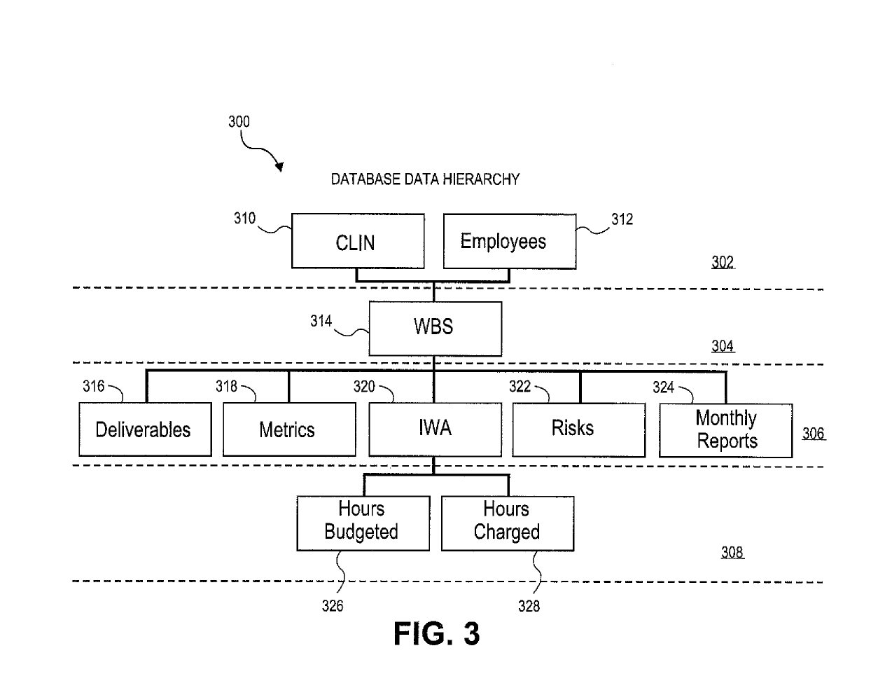

In embodiments, the forms module 206 can be configured to classify the entered data, relating to governmental projects, in a hierarchical structure based on the rules of governmental contracting and the data required to meet the rules of governmental contracting. FIG. 3 illustrates an exemplary database data hierarchy 300 that defines the interrelationship of data classified and stored in the PM database 118. While FIG. 3 illustrates an exemplary data relationship, one skilled in the art will realize that the database data hierarchy 300 can be modified as the rules of governmental contracting are modified.

In embodiments, as shown in FIG. 3, the PM application 102 can be configured to utilize the database data hierarchy 300 that employs four levels of data relationship, 302, 304, 306 and 308. At the top level 302, the PM application 102 classifies all data stored in the PM database 118 according to two types of unique identifiers, contract line item number (CLIN) 310 and employee identification 312. The CLIN 310 can be an identifier (e.g. number, name, etc.) that uniquely identifies the contract under which the data in the PM database 118 relates. For example, the CLIN 310 can be a contract or sub-contract number assigned by the governmental agency. The employee identification 312 can be an identifier that uniquely identifies different employees of the governmental contractor. For example, the employee identification 312 can be an employee name, user access name, social security number, and the like. All data stored in the PM database 118 can be associated with a CLIN 310 and one or more employee identifications 312. The CLIN 310 and employee identification 312 can be entered and stored in the PM database 118 at any point, together or separate for classifying and storing information at the levels 304, 306, and 308.

In embodiments, at the level 304, the PM application 118 classifies data according to a work break down (WBS) identifier 314. The WBS identifier 314 can identify the different tasks that are performed under the governmental contract. Each WBS identifier 314 can be associated with a CLIN 310 and one or more employee identifications 312. Because each WBS identifier 314 is associated with one CLIN 310, data associated with a particular WBS identifier 314 can be modified without affecting other data associated with other WBS identifiers 314.

In embodiments, at the level 306, the PM application 102 classifies particular data, associated with a particular WBS identifier 314, according to several topics associated with governmental contracting rules: deliverables 316, metrics 318, staffing (IWA) 320, risks 322, and monthly reports 324. The deliverables topic 316 can include all data related to services and products that are to be provided under the governmental contracts. The metrics topic 318 can include all data related to parameters by which the governmental agency measures success of the governmental project and compliance with the governmental contract. The IWA topic 320 can include all data related to the employees of the governmental contractor working on the governmental project, such as identification of employees approved to staff the governmental project, hours budged for the governmental project, hours charged to the governmental contract, etc. The risk topic 322 can include all data related to various risks associated with the governmental project and contract, such as situations (resources failure, staffing availability, etc.) in which the governmental contractor can experience problems servicing the governmental project. The monthly reports topic 324 can include all data related to the monthly reporting required under governmental contracting rules, such as types of reports, data required in the reports, frequency of the reports, due dates of the reports, etc.

In embodiments, at level 308, the IWA topic 320 can be further classified into two sub-topics: hours budgeted sub-topic 326 and hours charged sub-topic 328. The hours budgeted sub-topic 326 can include all data related to the amount of work hours budgeted to the governmental projects as specified by the governmental contract. The hours charged sub-topic 328 can include all data related to the amount of work hours charged to the governmental contract.

In embodiments, the PM application 102 can utilize the database data hierarchy 300 illustrated in FIG. 3 to generate and populate tables 222 for storing the data related to governmental projects and to extract data from the tables 222. The PM application 102 can be configured to maintain a table 222 for each of the topics 316-324 and the sub-topics 326-328. Each table 222, related to a particular topic, can include fields for storing data related to the particular topic. In order to implement the database data hierarchy 300, each field of data in a table 222 can include a reference to the CLIN 310 and WBS identifier 314 associated with the data stored in that field. Likewise, each field of data in a table 222 can also include a reference to the one or more employee identifications 312 associated with the data stored in that field. By separating data into unique tables 222 associated with the topics 316-324 and the sub-topics 326-328, the PM application 102 can easily identify and retrieve any data stored in the PM database 118 and can create any report that the governmental agency requires under the contract. Additionally, the PM application 102 can receive new data without having to alter or update other data stored in the PM database 118. Likewise, if the government agency alters any of the requirements of the contract, the PM application 102 can add new topics and tables to store any new data.

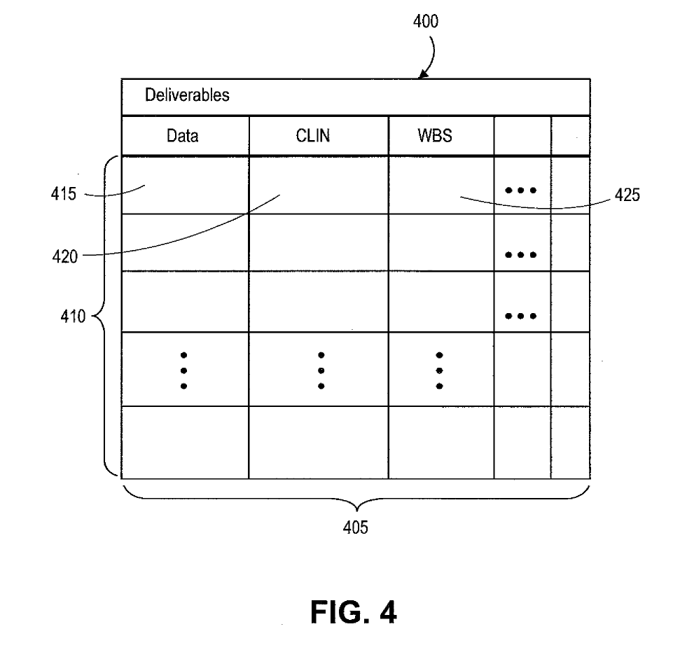

FIG. 4 illustrates an exemplary table 400 for storing data according to the database data hierarchy 300 illustrated in FIG. 3. As illustrated, the table 400 can be configured to store data related to the deliverables topic 316. The table 400 can include a number of columns 405 and rows 410 to store the data according to the database data hierarchy 300 which allows the data contained within the tables 400 to be easily identified. For example, each row 405 can include a field 415 for storing data defining a particular deliverable. Additionally, each row 405 can include a field 420 for storing the CLIN 310 and a field 425 for storing the WBS identifier 314 associated with the particular deliverable defined in field 415. One skilled in the art will realize that the table 400 can include additional fields for storing data related to a particular deliverable, such as employees identifications 312 associated with the particular deliverables.

In embodiments, once data is entered and passed to the forms module 206, the forms module 206 can be configured to classify the data according to the database data hierarchy 300 and to store the data in the appropriate tables 222 according to the database data hierarchy 300. In order to assist in classifying and storing the data, the forms 220, for entering data, can direct the user to enter the appropriate unique identifiers when entering data in the PM database 118. For example, when a user enters data regarding the deliverables topic 316, the user interface 204 can generate and provide a GUI including a form 220, provided by the forms module 206, which requires that a user specify a CLIN identifier 310 and WBS identifier 314 when entering data associated with the deliverables topic 316. When classifying and storing the data, the forms module 206 can identify the CLIN identifier 310 and WBS identifier 314 associated with the data entered and can store the entered data in the appropriate table 222.

In embodiments, when providing forms to the user interface 204, the forms can include data that is stored in the PM database 118. For example, when entering data, the user can need to be aware of data already existing in the PM database 118 such CLIN identifiers 310, employee identifications 312, WBS identifiers 314, and the topics 316, 318, 320, 322, 324, 326, and 328. The forms module 206 can be configured to populate the forms 220 with data already stored in the tables 222. To achieve this, the forms module 206 can be coupled to the search module 210. The forms module 206 can be configured to communicate with the search module 210 to search the data in a structured manner. The search module 210 can be coupled to the database interface 208 in order to access the PM database 118. The search module 210 can be configured to search the tables 222 in the PM database 118 utilizing queries that are associated with the forms 220 and the tables 222. The queries can be configured search the tables 222 according to the data relationships defined in the database data hierarchy 300. As such, the search module 210 can locate specific data needed by the forms 220 without searching the entire PM database 118. Likewise, the search module 210 can be configured to utilize any type of searching algorithms or schemes to augment the queries, such as keyword searches, text-based search, and other types of structured database searches.

In embodiments, once the search module 210 has searched the PM database 118, the search module 210 can be configured to return the results of the search to the forms module 206. The results can include a reference that includes the location of data in the tables 222 required to populate the forms. The forms module 206 can be configured to retrieve the data from the tables 222 based on search results. Likewise, the search module 210 can be configured to retrieve the located data and to return the located data to the forms module 206 in order to populate the forms 220.

In embodiments, the user interface 204 can be configured to generate GUIs which include controls, widgets, fields and the like that allow the user to retrieve data stored in the PM database 118. As such, the user interface 204 can be configured to receive a request to retrieve the data via the GUIs. Once the request is received, the user interface 204 can be configured to pass the request to the forms module 206. The forms module 206 can be configured to utilize the search module 210 to locate and retrieve the stored data according to the request and to pass the retrieved data to the user interface 204. The user interface 204 can be configured to provide the retrieved data to the user in the GUIs.

In embodiments, the PM application 102 can be configured to control the access to the PM application 102 and the PM database 118 by different users. Prior to allowing a user to access the PM application 102, the user interface module 204 can be configured to generate and provide an access GUI to the user. The user interface module 204 can generate the access GUI to include fields, widgets and controls to allow the user to enter access information. The access information can include information that uniquely identifies the user (e.g. user access name) and a secure token (e.g. password) that verifies the user's identity. To generate and provide the access GUI, the user interface module 204 can be configured to request the access form 220 from the forms module 206.

In embodiments, once a user enters the access information, the user interface 204 can be configured to pass the access information to the access control module 212. The access control module 212 can be coupled to the control module 202 and the database interface 208. The access control module 212 can be configured to receive the access information from the user interface 204, to compare the received access information to access control records 224 maintained in the PM database 118.

In embodiments, the access control records 224 can be configured to include the unique identifiers of the users allowed to access the PM application 102 associated with the secure token of the user. The access control records 224 can also be configured to include access rights associated with each unique identifier of a user. The access rights can define the functionality of the PM application 102 that a particular user can access. For instance, the PM application 102 can allow and restrict access to different functionality, such as entering data, modifying data, viewing data, generating reports, and the like. Additionally, the PM application 102 can allow and restrict access to different functionality for different categories in the database data hierarchy 300. For example, the PM application 102 can allow and restrict access to entering data for a particular CLIN 310 and WBS identifier 314.

In embodiments, once the access control module 212 has compared the received access information to the access control records 224, the access control module 212 can be configured to notify the user interface 204 and control module 202 of the results of the comparison (i.e. whether access information matches the access control records and access rights if the access information matches). As such, the PM application, via the control module 202 and the user interface 204, can be configured to control the user's access to the PM application 102 and the PM database 118. For example, the control module 202 can be configured to the PM application 102 to block all access to the PM application 102 if the access information does not exist in the access control records 224 or does not match the information contained in the access control records 224. Likewise, for example, the control module 202 can enforce the access right contained the access controlled records 224 by limiting the functionality of the PM application 102.

In embodiments, the PM application 102 can be configured to allow access information of users to be entered and stored in the access control records 224. The user interface 204 can be configured to generate and provide an administrator GUI to a user, such as an administrator. The user interface module 204 can generate the administrator GUI to include fields, widgets and controls to allow the user to enter access information for different users for storage in the access control records 224. The access information can include information that uniquely identifies the users (e.g. users access name), secure tokens (e.g. passwords) that verifies the users' identities, and access rights for the users. To generate and provide the access GUI, the user interface module 204 can be configured to request the administrator form 220 from the forms module 206. Once the user enters the access information, the user interface 204 can be configured to pass the access information to the access control module 212. The access control module 212 can be configured to store the access information in the access control records 224 maintained in the PM database 118.

In embodiments, the PM application 102 can be configured to allow the user to generate reports as required by the rules of governmental contracting. To achieve this, the user interface 204 can be configured to generate and provide the GUIs with fields, controls, and widgets that allow the user to select different types of reports to generate and the data to include in the selected reports. Once the user interface 204 receives a request for a report from the GUIs, the user interface 204 can be configured to pass the received request to the reports module 214.

In embodiments, the reports module 214 can be coupled to the control module 202 and the search module 210. The reports module 214 can be configured to include various formats of the reports to be generated by the PM application 102. These formats can represent the various reports that are required by the governmental agencies as required by the rules of governmental contracting. The formats can be configured to specify the structure and makeup of the reports and the particular data to be include in the reports. Once received, the reports module 214 can be configured to identify the format from the received request and the data as requested by the user to included in the report. The reports module 214 can be configured to instruct the search module 210 to search the tables 222 of the PM database 118. Once received from the search module 210, the reports module 214 can be configured to generate a report utilizing the format and the retrieved data from the search module 210. Once the report is generated, the reports module 214 can pass the generated report to the user interface 204. The user interface 204 can be configured to provide the generated report to the user in a GUI.

In embodiments, the PM application 102 can be configured to detect, track, and log any errors that occur in the PM application 102. To achieve this, the error module 216 can be coupled to the control module 202, the database interface 208, and the communication module 218. The error module 216 can be configured to receive error messages from the control module 202 upon the occurrence of error in any of the modules of the PM application 102 or the PM database 118. For example, the control module 202 can provide error messages if a specific form 220 cannot be located by forms module 206. Once an error message is received, the error module 216 can be configured to store the message identifying the error in an error log 226. Additionally, the error module 216 can be configured to notify the user via the user interface 204.

In embodiments, the PM application 102 can be configured to utilize a communication application 228, such as electronic mail (email) application, messaging application, etc., stored on and executed by the computing system executing the PM application 102 in order to communicate with other computer systems and users. To achieve this, the PM application 102 can utilize the communication module 218. The communication module 218 can be configured to interface with the communication application 228 to communicate with other computing systems and user, for instance, by generating and sending emails or messages. The communication module 218 can be configured as an API, remote procedure call, or other programming structure.

In embodiments, the PM application 108 can be configured to communicate via the communication application 228 upon the occurrence on any number of events. For example, the user interface 204 can be configured to include, in the GUIs, controls, fields and widgets that allow the user to initiate communications via the communication application 228. In this example, the user interface 204 can be configured to pass a command to the communication module 218 to initiate the communication application 228. In another example, upon the occurrence of an error, the error module 216 can be configured to report the error via the communication application 228. In this example, the error module 216 can be configured to pass a command, along with the appropriate error log 226, to the communication module 218 in order to communicate with error log to other computing systems and/or users.

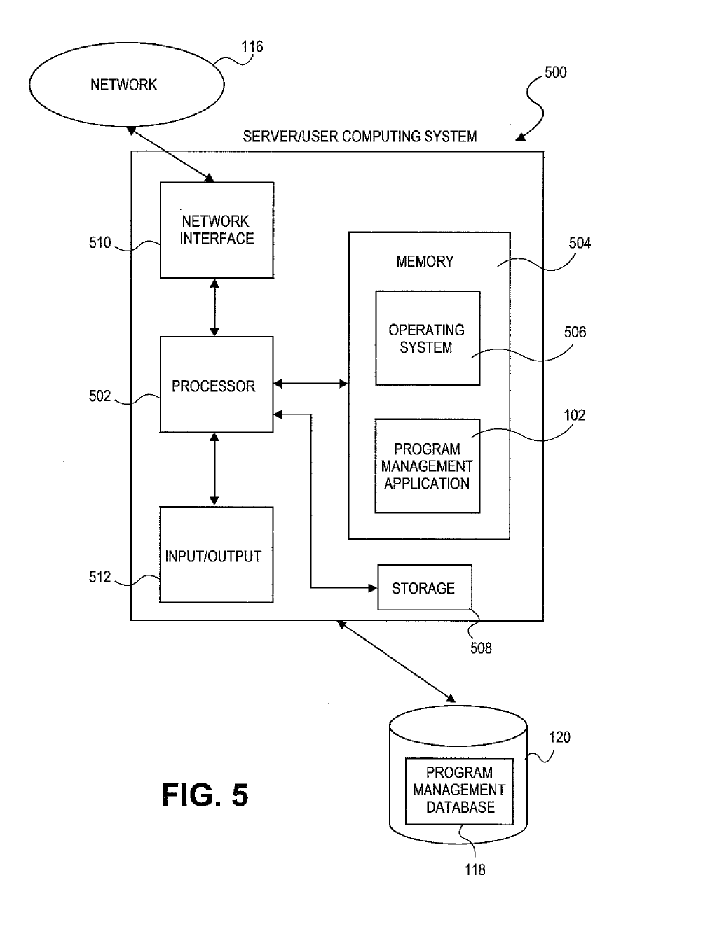

FIG. 5 illustrates an exemplary diagram of hardware and other resources that can be incorporated in a computing system 500 configured to communicate with the network 116, and execute the PM application 102 according to embodiments. For example, the computing system 500 can be used as any of the computing systems of the environment 100. While FIG. 5 illustrates exemplary components of the computing system 500, one skilled in the art will realize that computing system 500 can include any number and types of component of conventional computing systems.

In embodiments as shown, the computing system 500 can include a processor 502 communicating with memory 504, such as electronic random access memory, operating under control of or in conjunction with operating system 506. Operating system 506 can be, for example, a distribution of the Linux operating system, the Unix operating system, the WINDOWS operating system or other open-source or proprietary operating system or platform. The memory 504 can serve as a storage and execution space for the operating system 506 and the PM application 102 during operation of the computing system 500.

In embodiments, the processor 502 also communicates with the computer readable storage medium 508, such as hard drives, optical storage, and the like. While illustrated as a local storage in computing system 500, the computer readable storage medium 508 can be separate from the computing system 500. The computing system 500 can utilize the computer readable storage medium 508 to store a copy of the PM application 102 and the operating system 506

In embodiments, the processor 502 further communicates with a network interface 510, such as an Ethernet or wireless data connection, which in turn communicates with one or more networks 116, such as the Internet or other public or private networks. The processor 502 further communicates with input/output devices such as keyboards, printers, display devices and the like.

Additionally, in embodiments as illustrated, the computing system 500 can communicate with the repository 120, which can be located externally from the computing system 500, in order to access the PM database 118. One skilled in the art will realize that the repository 120 can be incorporated as a component of the computing system 500.

As illustrated, the PM application 102 can be implemented as a software application or program capable of being executed by a conventional computer platform. Likewise, the PM application 102 can also be implemented as a software module or program module capable of being incorporated in other software applications and programs. In either case, the PM application 102 can be implemented in any type of conventional proprietary or open-source computer language.

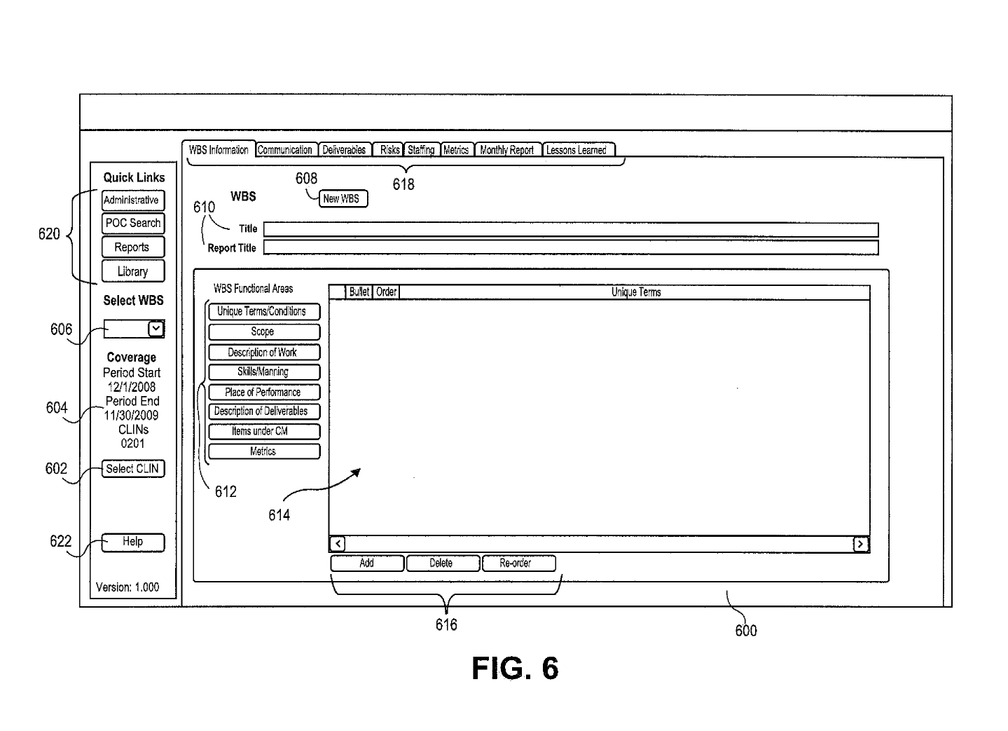

As mentioned above, the PM application 102 is configured to generate various GUIs to allow a user to interact with the PM application 102 in order to enter and store data relating to governmental projects in the PM database 118, to retrieve and view data relating to governmental projects from the PM database 118, to generate and output reports relating as required by governmental contracting rules, and to set and alter access rights of the users to the PM application 102. FIGS. 6-17 illustrate various exemplary GUIs generated by the PM application 102 utilizing the components described above in FIG. 2, according to various embodiments.

In embodiments, FIG. 6 illustrates an exemplary GUI 600 for entering and accessing information for different WBS identifiers 314. As illustrated, the GUI 600 can be configured to include a button 602 to allow a user to select a particular CLIN 310 for which to enter data associated with a WBS identifier 314 and a field 604 for displaying details on the selected CLIN 310. Likewise, the GUI 600 can be configured to include a selection menu 606 to allow the user to select an existing WBS identifier 314 for which to enter data. The GUI 600 can be configured to include a button 608 to create a new WBS identifier 314 for the selected CLIN 310 and fields 610 for entering information describing the new WBS identifier 314. Additionally, the GUI 600 can be configured to include a number of buttons 612 that allows the user to view data for the topic associated with the selected WBS identifier 314 and a field 614 for viewing the data for the topics. The GUI 600 can be configured to include button 616 to allow the user to add, delete or reorder any of the data for the topics selected by the buttons 612.

In embodiments, the GUI 600 can be configured to include various buttons that cause to PM application 102 to provide additional GUIs. As illustrated, the GUI 600 can be configured to include a number of tabs 618, which allow the user to access other GUIs associated with the tab label, such as “communication”, “deliverables”, “risks”, “staffing”, “metrics”, “monthly reporting”, and “lessons learned”. Likewise, the GUI 600 can be configured to include a number of quick link buttons 620 which allow the user to access GUIs that are most frequently accessed and provide additional functionality of the PM application 102. Additionally, the GUI 600 can be configured to include a button 622 which allows the user to access help information for the PM application 102, such as a user manual for the PM application 102.

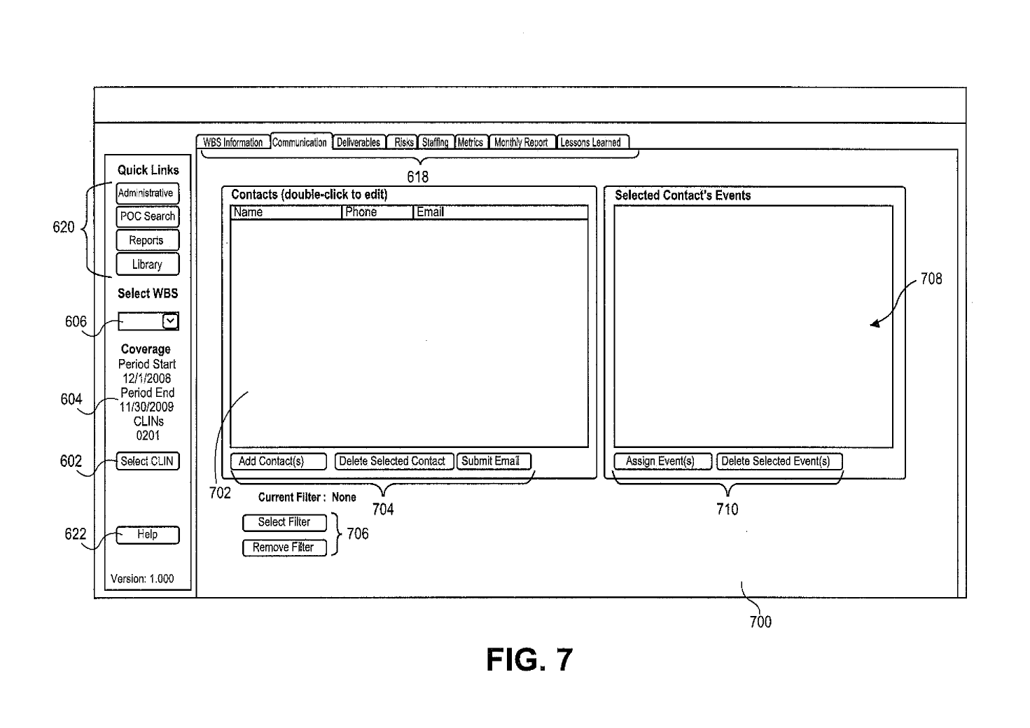

FIG. 7 illustrates another exemplary GUI 700, which can be accessed by selecting the “communication” tab of the tabs 618. The GUI 700 can be configured to allow the user to enter data regarding persons of contact associated with a selected CLIN 310 and WBS identifier 314. As illustrated, the GUI 700 can be configured to include a selectable field 702 that displays persons of contact associated with the selected CLIN 310 and WBS identifier 314. The field 702 can include data such as name of the person, phone number and email address. The GUI 700 can be configured to include buttons 704 that allow the user to add contacts, delete contacts, or communicate with selected contracts, for example, utilizing a communication application 228 (e.g. email application). The GUI 700 can be configured to include buttons 706 that allow the user to filter the contact displayed in the selectable field 702.

In embodiments, once a contact has been selected in selectable field 702, the GUI 700 can be configured to include a selectable field 708 that displays events associated with the selected contact. The events can include event that are associated with the governmental project, such as reports due and the like. The GUI 700 can be configured to include buttons 710 that allow the user to enter new events or delete events selected in the selectable field 708.

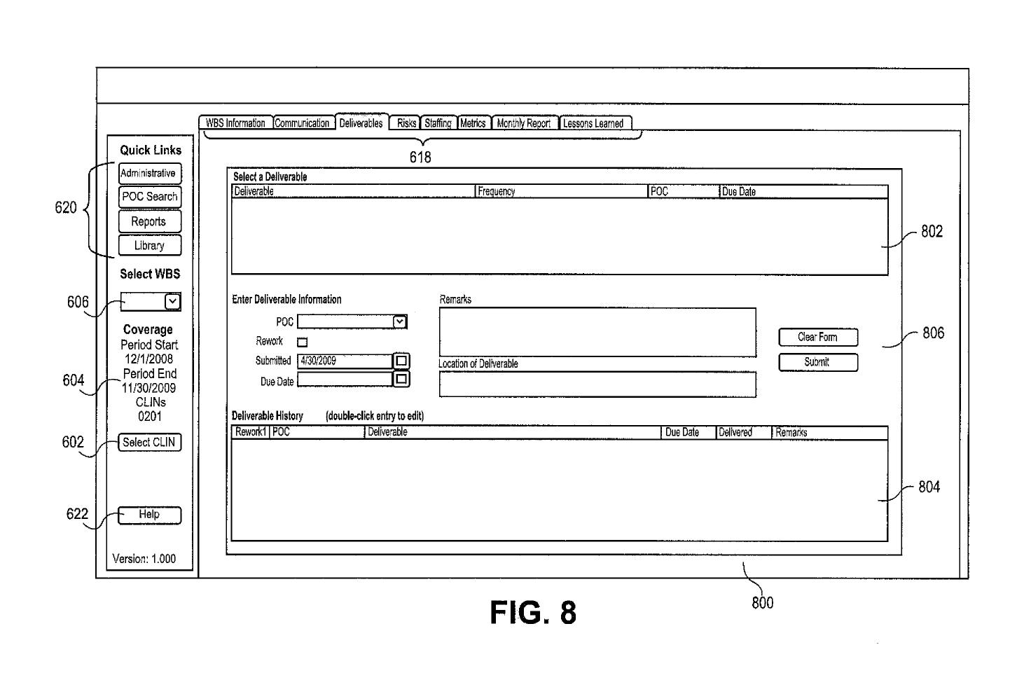

FIG. 8 illustrates another exemplary GUI 800, which can be accessed by selecting the “deliverables” tab of the tabs 618. The GUI 800 can be configured to allow the user to view and enter data regarding deliverables associated with a selected CLIN 310 and WBS identifier 314. As illustrated, the GUI 800 can be configured to include a selectable field 802 that displays deliverables associated with the selected CLIN 310 and WBS identifier 314. Additionally, the GUI 800 can be configured to include a selectable field 804 that displays information associated with a deliverable selected in the selectable field 802. The GUI 800 can also be configured to include a data entry section 806. The data entry section 806 can be configured to include buttons and fields that allow the user to enter information about a deliverable selected in the selectable field 802, such as point of contact, data submitted, date due, remarks, location of deliverable, and the like.

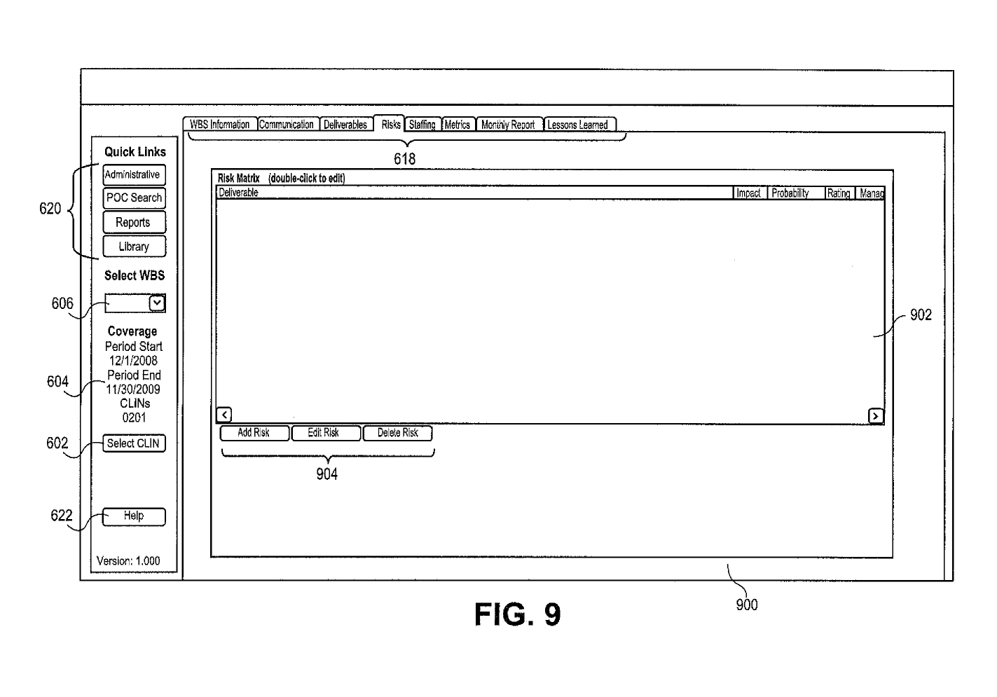

FIG. 9 illustrates another exemplary GUI 900, which can be accessed by selecting the “risks” tab of the tabs 618. The GUI 900 can be configured to allow the user to view and enter data regarding risks associated with a selected CLIN 310 and WBS identifier 314. As illustrated, the GUI 900 can be configured to include a selectable field 902 that displays risks associated with the selected CLIN 310 and WBS identifier 314. Additionally, the GUI 900 can be configured to include buttons 904 that allow a user to add risk, edit risks selected in the selectable field 902, and edit risks selected in the selectable field 902.

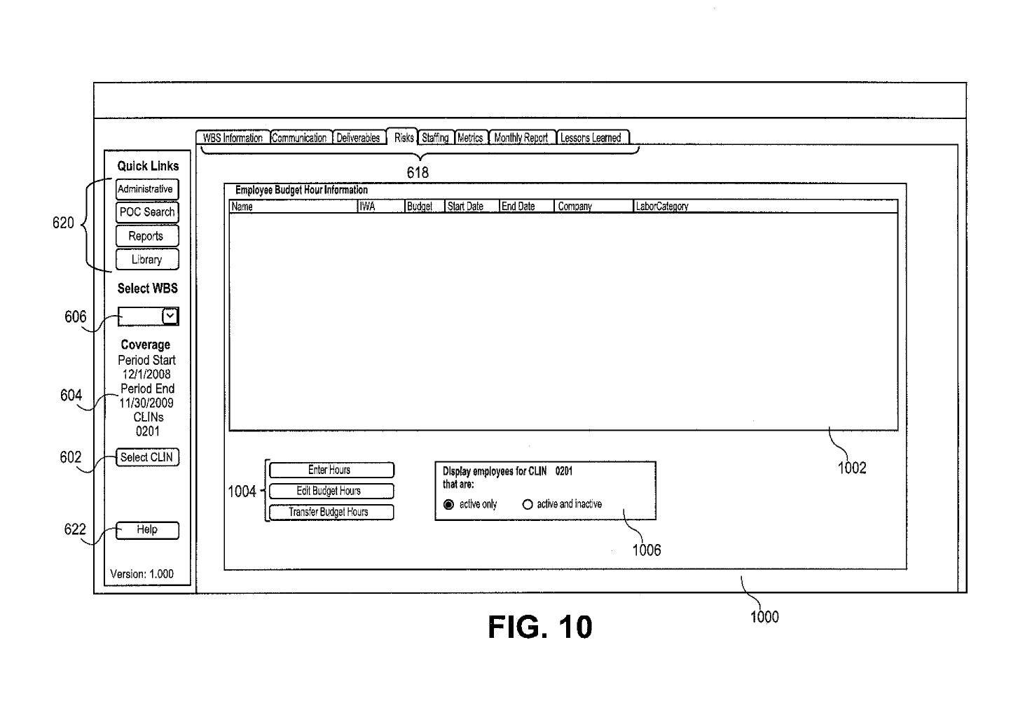

FIG. 10 illustrates another exemplary GUI 1000, which can be accessed by selecting the “staffing tab” of the tabs 618. The GUI 1000 can be configured to allow the user to view and enter data regarding employees and hours associated with a selected CLIN 310 and WBS identifier 314. As illustrated, the GUI 1000 can be configured to include a selectable field 1002 that displays employees associated with the selected CLIN 310 and WBS identifier 314. The GUI 1000 can be configured to include buttons 1004 that allow the user to enter hours for a selected employee, edit budgeted hours for a selected employee, and transfer budgeted hours between selected employees. The GUI 1000 can also be configured to include buttons 1006 that allows the user to filter the employees displayed in the selectable field 1002 to active or active and inactive.

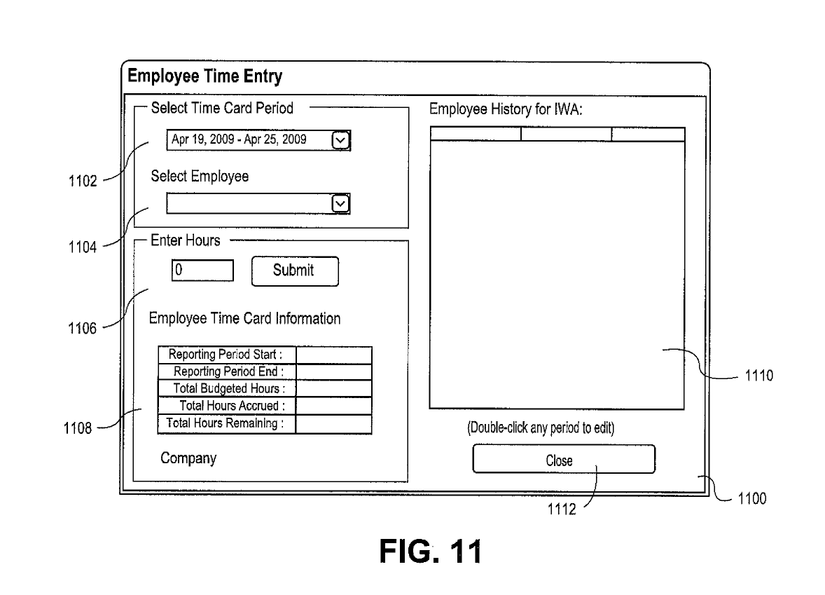

FIG. 11 illustrates another exemplary GUI 1100, which can be accessed by selecting a button 1004 in the GUI 1000. The GUI 1100 can be configured to allow the user to enter hours worked for a particular employee. The GUI 1100 can be configured to include a selectable menu 1102 that allows the user to select a time period to enter hours work and a selectable menu 1104 that allow the user to select an employee to enter hour worked. The GUI 1100 can also be configured to include a field 1106 that allows the user to enter hour worked for the selected employee during the selected time period. The GUI 1100 can be configured to include a field 1108 that displays other information associated with the selected employee such as reporting period, total budgeted hours, total hours accrued, and total hours entered. The GUI 1100 can also be configured to include a field 1110 that displays previous time entries for the selected employee. The GUI 1100 can be configured to include a button 1112 that allows the user to close the GUI 1100.

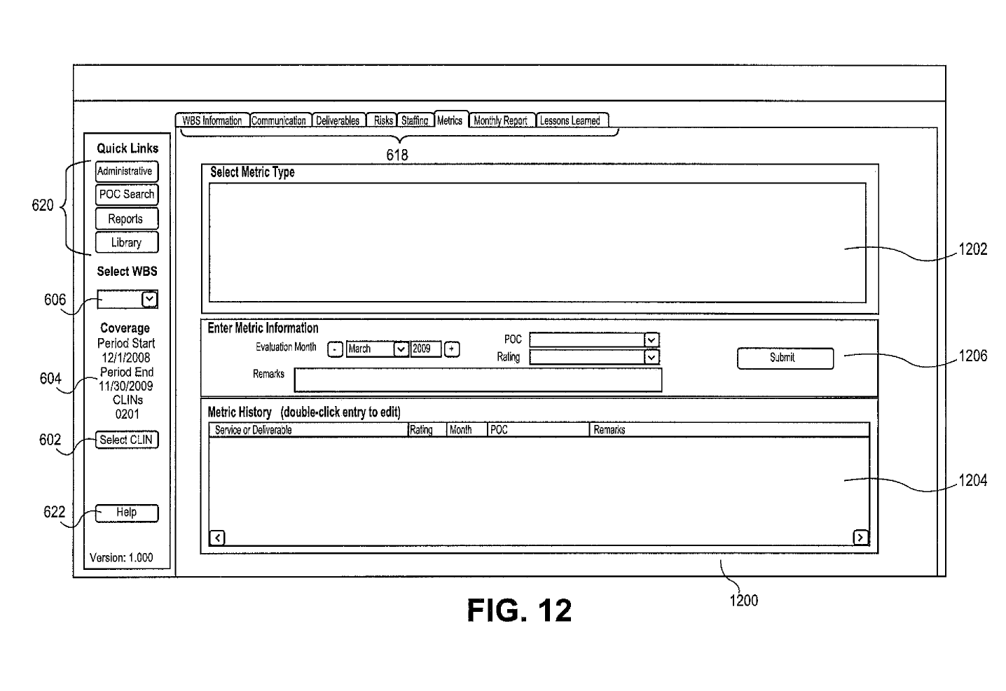

FIG. 12 illustrates another exemplary GUI 1200, which can be accessed by selecting the “metrics” tab of the tabs 618. The GUI 1200 can be configured to allow the user to view and enter data regarding metrics associated with a selected CLIN 310 and WBS identifier 314. As illustrated, the GUI 1200 can be configured to include a selectable field 1202 that displays metrics associated with the selected CLIN 310 and WBS identifier 314. Additionally, the GUI 1200 can be configured to include a selectable field 1204 that displays information associated with a metrics selected in the selectable field 1202. The GUI 1200 can also be configured to include a data entry section 1206. The data entry section 1206 can be configured to include buttons and fields that allow the user to enter information about a metric selected in the selectable field 1202, such as evaluation month, point of contact, rating, remarks, and the like and a button to submit the entered data.

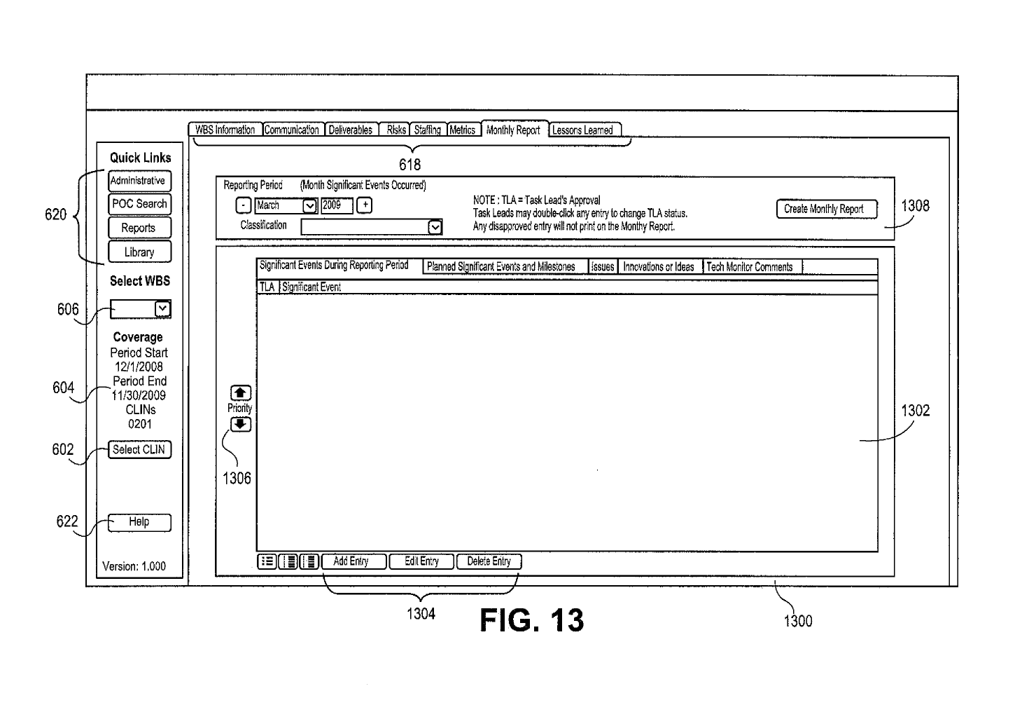

FIG. 13 illustrates another exemplary GUI 11300, which can be accessed by selecting the “monthly report” tab of the tabs 618. The GUI 1300 can be configured to allow the user to view and enter data regarding events associated with a selected CLIN 310 and WBS identifier 314. As illustrated, the GUI 1300 can be configured to include a selectable field 1302 that allow the user to view and select events associated with the selected CLIN 310 and WBS identifier 314. The GUI 1300 can be configured to include buttons 1304 that allow the user to add new events, edit selected events, and delete selected events. The GUI 1300 can also be configured to include buttons 1306 that allow the user to list the event in the selectable field 1302 by priority. The GUI 1300 can also be configured to include a reports section 1308. The reports section 1308 can be configured to include fields and buttons that allow the user to create a monthly report associated with the events in the selectable field 1302.

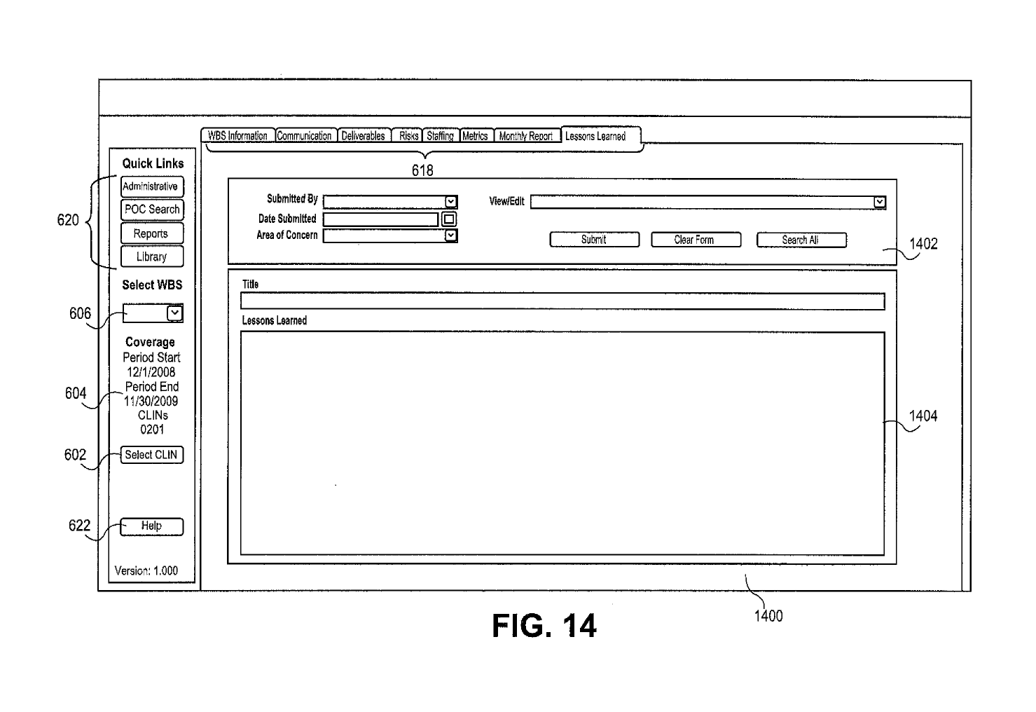

FIG. 14 illustrates another exemplary GUI 1400, which can be accessed by selecting the “lessons learned” tab of the tabs 618. The GUI 1400 can be configured to allow the user to view and enter data regarding lessons learned associated with a selected CLIN 310 and WBS identifier 314. As illustrated, the GUI 1400 can be configured to include a section 1402 that allows a user to create a new lesson learned or view and edit an existing lesson learned. The section 1402 can be configured to include menu and buttons that allow the user to select an existing lesson learned or specify details of a new lesson learned such as name of the person submitting the lesson learned, date the lesson learned was submitted, and the subject of the lesson learned. The GUI 1400 can also be configured to include a section 1404 that allows the user to view the existing lesson learned, modify the existing lesson learned, and add data about a new lesson learned.

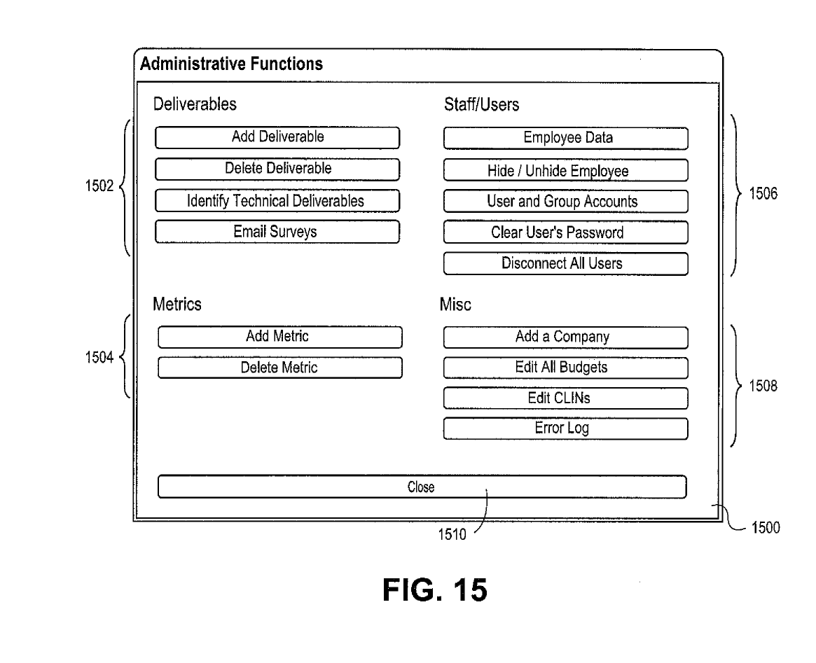

FIG. 15 illustrates an exemplary administrator GUI 1500, which can be accessed by selecting the “administrative” button of the quick link buttons 620. The GUI 1500 can be configured to allow a user, such as an administrator, to perform various administrative actions associated with the PM application 102. Because GUI 1500 allows administrative functions, the PM application 102 can be configured to limit access to GUI 1500 to users with access right at the administrator level. As such, prior to allowing access to GUI 1500, the PM application 102 can be configured to provide an access GUI to the user to enter access information as described.

In embodiments, as illustrated, the GUI 1500 can be configured to include buttons 1502 that allow the user to add, delete and define deliverables. Once added using GUI 1500, the added deliverables can be accessible through GUI 800. Likewise, the GUI 1500 can be configured to include buttons 1504 that allow the user to add and delete metrics. Once added using GUI 1500, the added metrics can be accessible through GUI 1500.

In embodiments, the GUI 1500 can also be configured to include buttons 1506 that allow the user to specify information about employees. The buttons 1506 can be configured to allow the user to enter employee identifications 312. The buttons 1506 can also be configured to allow the user to control access to the PM application 102 such as defining access information for employees and access rights for the employees.

In embodiments, the GUI 1500 can also be configured to include buttons 1508 that allow the user to specify other miscellaneous actions such as add governmental contractors, edit budgets edit CLINs 310, and view and edit error logs. The GUI 1500 can be configured to include a button 1510 that allows the user to close the GUI 1500.

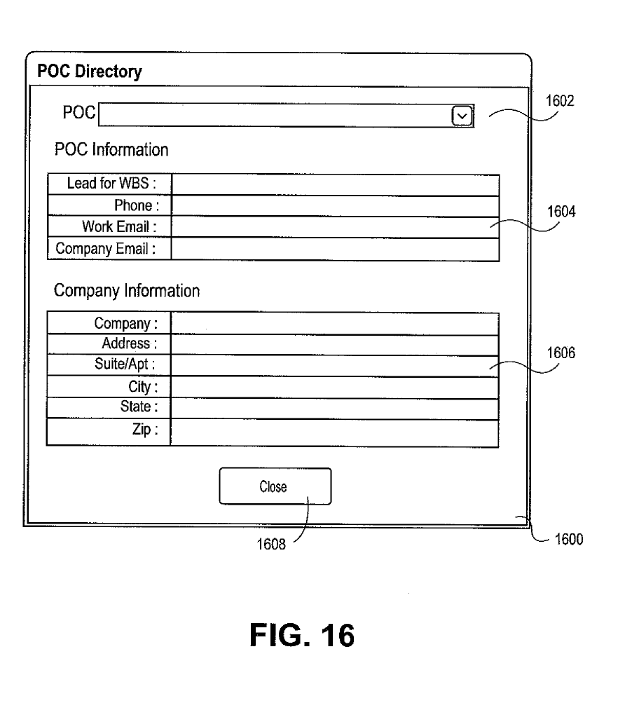

FIG. 16 illustrates another exemplary GUI 1600, which can be accessed by selecting the “POC” search button of the quick link buttons 620. The GUI 1600 can be configured to allow the user to search for points of contact and view data for the points of contact. The GUI 1600 can be configured to include a selectable menu 1602 that allows the user to view all points of contact and select one or more of the point of contact. The GUI 1600 can be configured to include a field 1604 that allows the user to view the data associated with the point of contact selected in the selectable menu 1602. Likewise, the GUI 1600 can be configured to include a field 1606 that allows the user to view the data for the governmental contractor associated with the point of contact selected in the selectable menu 1606.

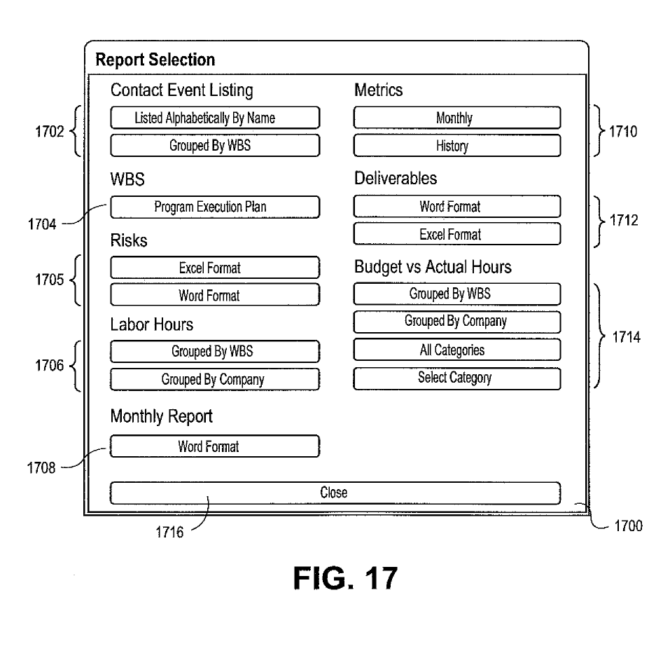

FIG. 17 illustrates another exemplary GUI 1700, which can be accessed by selecting the “reports” button of the quick link buttons 620. The GUI 1700 can be configured to allow the user to generate reports for the various topics associated with CLINs 310 and WBS identifiers 314. As illustrated, the GUI 1700 can be configured to include buttons 1702 that allow the user to generate reports that display point of contact listing for events. The buttons 1702 can be configured to allow the user to arrange the reports alphabetically by name or grouped by WBS identifier 314.

In embodiments, the GUI 1700 can be configured to include button 1704 that allows a user to generate a report, which provides data for a WBS identifier 314. The button 1704 can be configured to generate a report that includes the execution plan for the WBS identifier 314. The GUI 1700 can also be configured to include buttons 1705 that allow a user to generate a report, which includes the risks for the WBS identifier 314. The buttons 1705 can be configured to allow the user to generate the report in a specific format such as MICROSOFT Word or MICROSOFT Excel. The GUI 1700 can also be configured to include buttons 1706 that allow the user to generate a report, which includes the hours worked on a governmental project. The buttons 1706 can be configured to allow the user to arrange the report so that the hours are grouped by WBS identifier 314 or grouped by company.

In embodiments, the GUI 1700 can be configured to include button 1708 that allows a user to generate a monthly report. The button 1708 can be configured to allow the user to generate the report in a specific format such as MICROSOFT Word. The GUI 1700 can also be configured to include buttons 1710 that allow the user to generate a report for metrics associated with a governmental project. The buttons 1710 can be configured to allow the user to generate the report based on a time period such as monthly or the entire history of the governmental project. The GUI 1700 can be configured to include button 1712 that allow the user to generate a report for the deliverables associated with a governmental project. The buttons 1712 can be configured to allow the user to generate the report in a specific format such as MICROSOFT Word or Excel.

In embodiments, the GUI 1700 can be configured to include buttons 1714 that allow a user to generate a report that compares budget hours to hour worked for a governmental project. The buttons 1714 can be configured to allow the user to arrange the report by WBS identifier 314 or by company and select specific WBS identifiers 314 to include in the report. The GUI 1700 can also be configured to include a button 1716 that allows the user to close the GUI 1700.

While FIGS. 6-17 illustrate exemplary GUIs that can be generated by the PM application 102, one skilled in the art will realize that any number and type of GUIs can be generated. For example, prior to providing any of the GUIs illustrated in FIGS. 6-17, the PM application 102 can be configured to provide an access GUI. The access GUI can be configured to include fields, widgets, controls, buttons, and the like to allow the user to enter access information in order to gain access to the PM application 102. Likewise, one skilled in the art will realize that the layout of the GUIs illustrated in FIGS. 6-17 is exemplary and that the design and layout of the GUIs can be modified without departing from the scope of the present teachings.

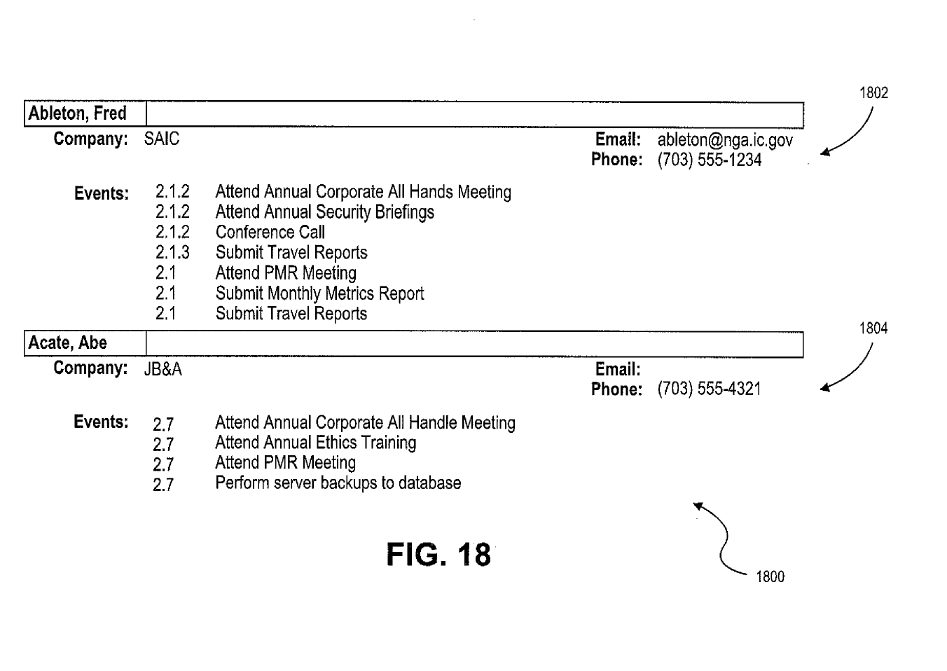

In embodiments, the PM application 102 can be configured to generate reports as specified by the users in the GUIs, such as GUI 1700. FIGS. 18-23 illustrate exemplary reports that can be generated by the PM application 102. In particular, FIG. 18 illustrates an exemplary report 1800, which can be generated by the user from the GUI 1700. As illustrated, report 1800 can be configured to display point of contact and events associated with the points of contact. The report 1800 can be configured to include tables 1802 and 1804, which are order in alphabetical order according to the point of contacts name. The tables 1802 and 1804 can include data such as the name of the point of contact, email address, phone number, company name, and events associated with the point of contact.

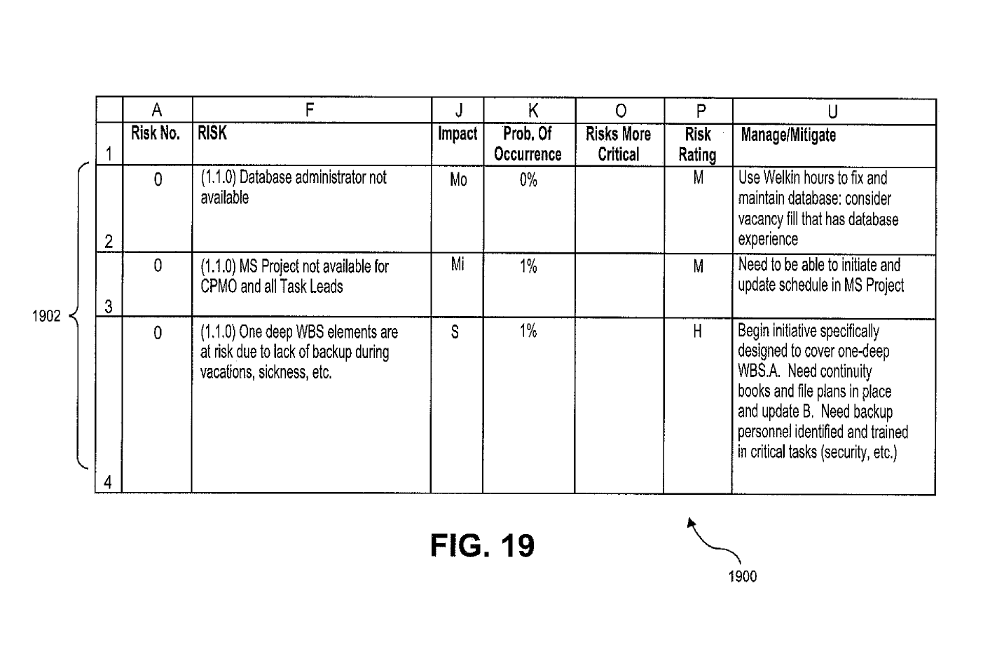

FIG. 19 illustrates an exemplary report 1900, which can be generated by the user from the GUI 1700. As illustrated, the report 1900 can be configured to display risks associated with a particular WBS identifier 314. The report 1900 can be configured as a table includes rows 1902. The rows 1902 can include various fields that describe the risks and data describing the risks.

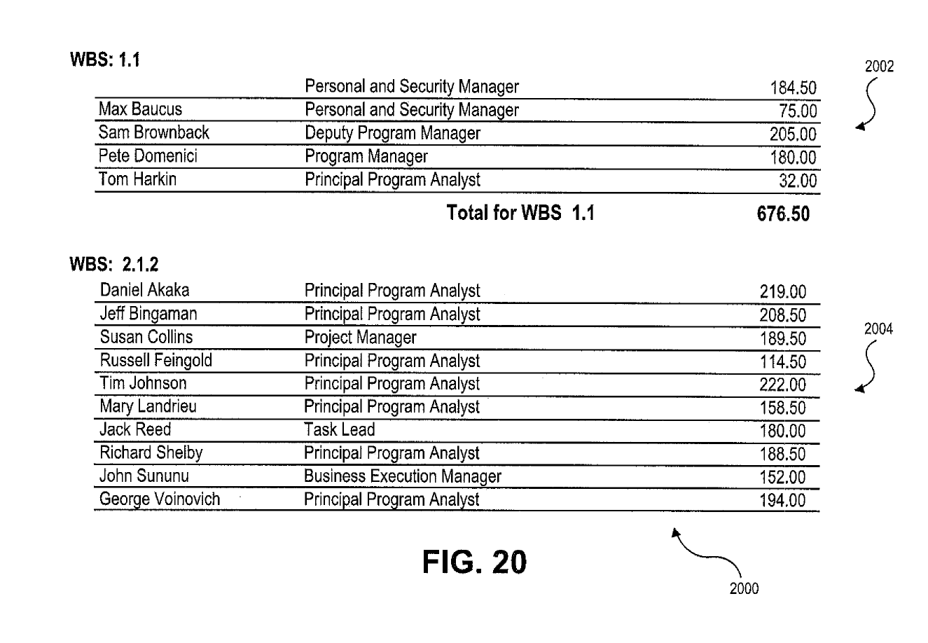

FIG. 20 illustrates an exemplary report 2000, which can be generated by the user from the GUI 1700. As illustrated, the report 2000 can be configured to show budgeted hours for employees for different WBS identifiers 314. The report 2000 can be configured as two tables 2002 and 2004. The tables 2002 and 2004 can be configured to include the names of the different employees and the hours budgeted to the employees under the governmental contract.

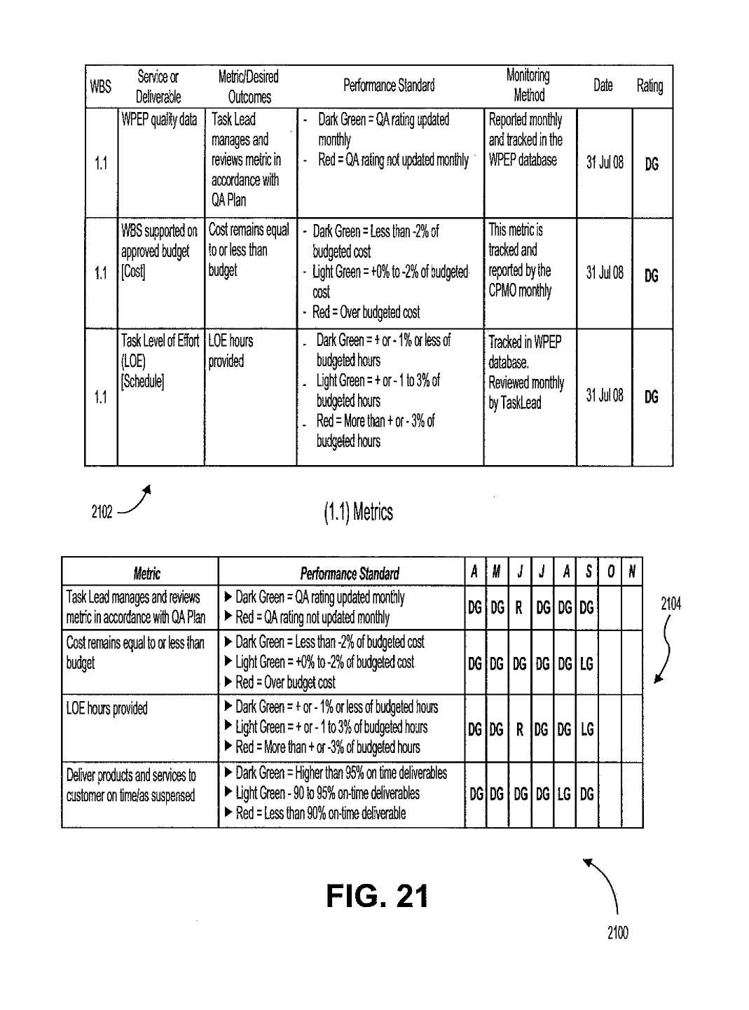

FIG. 21 illustrates an exemplary report 2100, which can be generated by the user from the GUI 1700. As illustrated, the report 2100 can be configured to show deliverables and metrics for a particular WBS identifier 314. The report 2100 can be configured as two tables 2102 and 2104. The table 2102 can be configured to include the deliverables associated with a particular WBS identifier 314 and other data describing the deliverable, such as an associated metric, performance standards, monitoring methods, due date, and rating. The table 2104 can be configured to include the metrics associated with the particular WBS identifier 314 and other data describing the metrics such as performance standards and a monthly breakdown of tasks.

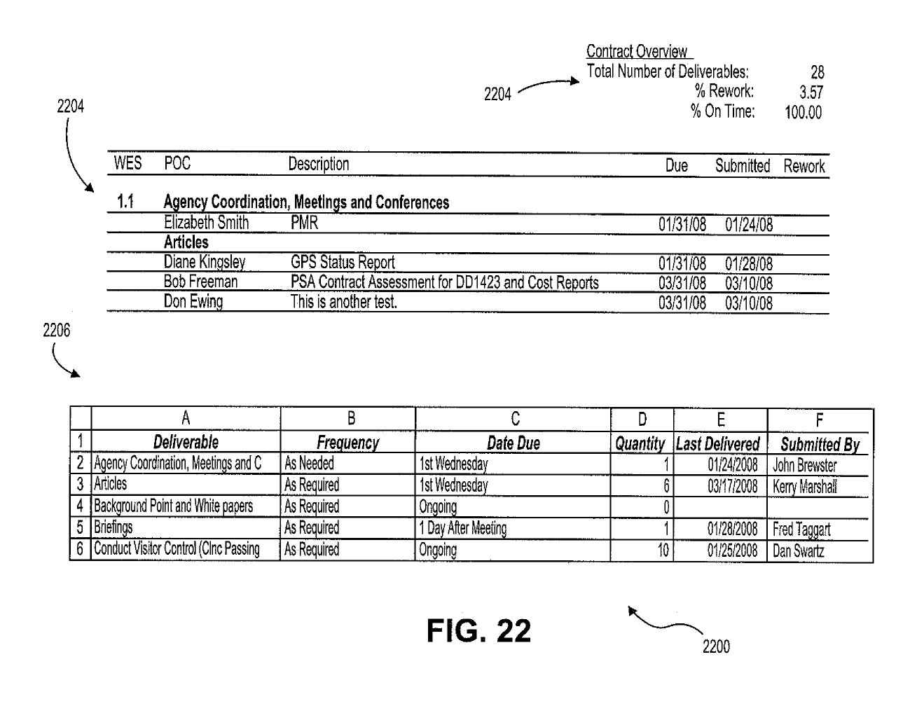

FIG. 22 illustrates an exemplary report 2200, which can be generated by the user from the GUI 1700. As illustrated, the report 2200 can be configured to show an overall snap-shot of the progress on a particular WBS identifier 314. The report 2200 can be configured to include an overview section 2202. The overview section 2202 can be configured to include the overall deliverable associated with the particular WBS identifier 314 and the success rate on the deliverables. The report 2200 can also be configured to include two tables 2204 and 2206. The table 2204 can be configured to include a listing of point of contact associated with the WBS identifier 314, the deliverables associated with the point of contact, and the point of contacts performance on the deliverables. Likewise, the table 2206 can be configured to include a breakdown of the deliverables and data associated with the deliverables such as frequency, due date, quantity, delivery date and point of contact responsible.

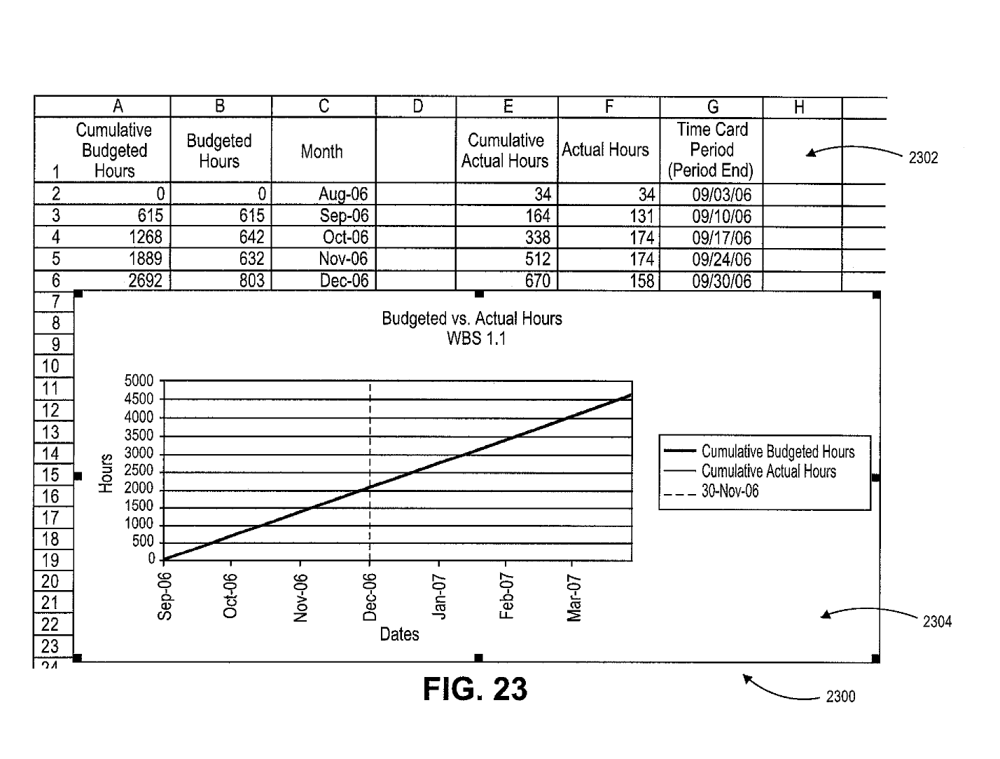

FIG. 23 illustrates an exemplary report 2300, which can be generated by the user from the GUI 1700. As illustrated, the report 2300 can be configured to a breakdown of hours budgeted versus hours worked for a particular WBS identifier 314. The report 2300 can be configured to include a table 2302 that include the hours budgeted for a time period and the hour worked for a time period. The report 2300 can be configured to include a graph 2304 that plots the budget versus hours worked for the time periods contained in the table 2302.

While FIGS. 18-23 illustrate exemplary reports that can be generated by the PM application 102, one skilled in the art will realize that any number and type of reports can be generated consistent with the present teachings. Likewise, one skilled in the art will realize that the layout of the reports illustrated in FIGS. 18-23 is exemplary and that the design and layout of the reports can be modified without departing from the scope of the present teachings.

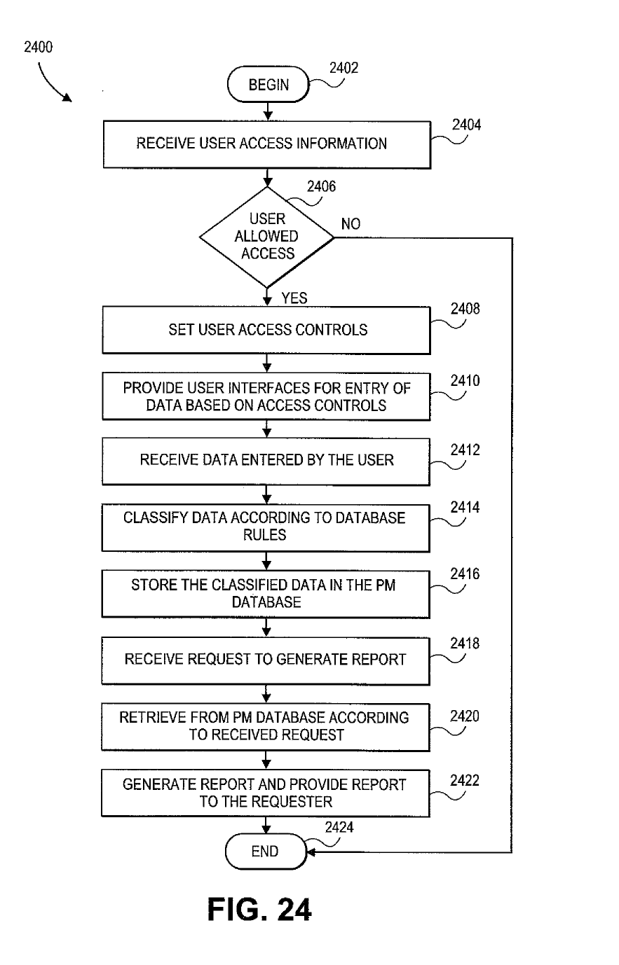

FIG. 24 illustrates an exemplary process 2400 for managing a governmental project utilizing the PM application 102. As illustrated, in 2402, the process 2400 can begin. In 2404, the PM application 102 can receive user access information. For example, upon initiation, the PM application 102 can generate a GUI and receive the access information via the GUI. The access information can include information that identifies the user and a security token that verifies the user's identity.

In 2406, the PM application 102 can determine whether to allow the user to access the PM application 102. For example, the PM application 102 can compare the received access information to access control records 224 stored in the PM database 118. If the access information matches the access control records 224, the PM application 102 can grant access to the PM application 102.

In 2408, the PM application 102 can set user access controls. For example, the PM application 102 can maintain access rights in the access control records 224. The access right can define the functionality level the user can access in the PM application 102. This can include rights to perform only certain actions, such as add data, modify data, view data, and the like. Additionally, this can include rights to perform certain actions for certain CLINs 310, WBS identifiers 314, and/or topics 316-328. The PM application 102 can retrieve and apply the access right when comparing the access information to the access control records 224.

In 2410, the PM application 102 can provide interactive interfaces for entry of data into the PM database 118. For example, the PM application 102 can generate and provide GUIs, such as the GUIs illustrated in FIGS. 6-17. In 2412, the PM application 102 can receive data from the user via the interfaces.

In 2414, the PM application 102 can classify the received data according to the database data hierarchy utilized by the PM application 102. For example, the PM application 102 can utilize the database data hierarchy 300, as illustrated in FIG. 3, in order to classify and store the data received from the user. In 2416, the PM application 102 can store the classified data in the PM database 118. For example, the PM application 102 can store the classified data in the tables 222 of the PM database 118.

In 2418, the PM application 102 can receive a request to generate a report. For example, the PM application 102 can generate and provide the GUIs, such as GUI 1700, that allow the user to request reports. In 2420, the PM application 102 can retrieve data from the PM database 118. For example, the PM application 102 can search the tables 222 for the data required in the report. In 2422, the PM application 102 can generate the report and provide the report to the user. For example, the PM application 102 can generate reports such as the reports illustrated in FIGS. 18-23.

In 2424, the processing can end, or return to any point and repeat.

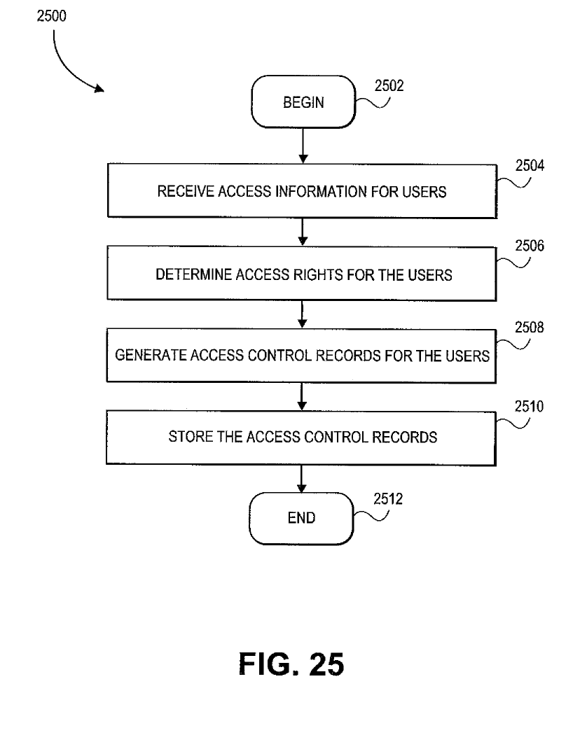

FIG. 25 illustrates an exemplary process 2500 for establishing user access to the PM application 102. In 2502, the process 2500 can begin. In 2504, the PM application 102 can receive access information for users. For example, the PM application 102 can generate and provide an administrator GUI, such as GUI 1500, to receive access information about the users.

In 2506, the PM application 102 can determine the access right from the users. For example, the PM application 102 can receive the access rights in from the administrator in the administrator GUI. The access right can define the functionality level the user can access in the PM application 102. This can include rights to perform only certain actions, such as add data, modify data, view data, and the like. Additionally, this can include rights to perform certain actions for certain CLINs 310, WBS identifiers 314, and/or topics 316-328.

In 2508, the PM application 102 can generate the access control records 224 for the users. For example, the access control records 224 can include the identification of the users associated with a security token and the access rights of the users. In 2510, the PM application 102 can store the access control records 224. For example, the PM application 102 can store the access control records 224 in the PM database 118.

In 2512, the processing can end, or return to any point and repeat.

Certain embodiments may be performed as a computer application or program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include computer readable storage devices and media, and signals, in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present teachings can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the teachings has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method for managing a governmental project, comprising;
providing an interface for entering data associated with the governmental project according to an identifier of the governmental project and topics associated with the governmental project;
classifying the data entered according to the identifier and the topics based on rules associated with governmental contracting; and
storing the classified data in a repository embodied in a computer readable storage medium.

2. The method of claim 1, wherein providing the interface, comprises:
generating the interface to include forms for entering the identifier and information on the topics.

3. The method of claim 1 wherein the interface is remotely accessible by a user.

4. The method of claim 1, further comprising:
receiving access information from a user;
authenticating the access information from the user to grant access to the user; and
establishing access rights of the user based on the access information, wherein the access rights define user ability to enter data for the topics.

5. The method of claim 1, further comprising:
receiving a request to retrieve stored data for the governmental project;
searching the repository for the stored data matching the request;
generating a report comprising the matching stored data; and
providing the report to an initiator of the request.

6. The method of claim 1, further comprising:
providing an administrator interface, the administrator interface comprising forms for receiving access information of users and access rights associated with the users; and
storing the access information and access rights associated with the users.

7. The method of claim 1, wherein storing the classified data comprises:
storing the classified data in tables of a database, wherein each table is associated with one of the topics.

8. The method of claim 1, wherein the topics comprise at least one of deliverables, metrics, work performed, staffing and risks.

9. The method of claim 1, wherein the identifier of the governmental project further comprises an identification of an employee associated with the governmental project.

10. A computer readable storage medium embodying instruction for causing a processor to perform the method comprising:
providing an interface for entering data associated with the governmental project according to an identifier of the governmental project and topics associated with the governmental project;
classifying the data entered according to the identifier and the topics based on rules associated with governmental contracting; and
storing the classified data in a repository embodied in a computer readable storage medium.

11. The computer readable storage medium of claim 10, wherein providing the interface, comprises:
generating the interface to include forms for entering the identifier and information on the topics.

12. The computer readable storage medium of claim 10, wherein the interface is remotely accessible by a user.

13. The computer readable storage medium of claim 10, the method further comprising:
receiving access information from a user;
authenticating the access information from the user to grant access to the user; and
establishing access rights of the user based on the access information, wherein the access rights define user ability to enter data for the topics.

14. The computer readable storage medium of claim 10, the method further comprising:
receiving a request to retrieve stored data for the governmental project;
searching the repository for the stored data matching the request;
generating a report comprising the matching stored data; and
providing the report to an initiator of the request.

15. The computer readable storage medium of claim 10, the method further comprising:
providing an administrator interface, the administrator interface comprising forms for receiving access information of users and access rights associated with the users; and
storing the access information and access rights associated with the users.

16. The computer readable storage medium of claim 10, wherein storing the classified data comprises:
storing the classified data in tables of a database, wherein each table is associated with one of the topics.

17. The computer readable storage medium of claim 10, wherein the topics comprise at least one of deliverables, metrics, work performed, staffing and risks.

18. The computer readable storage medium of claim 10, wherein the identifier of the governmental project further comprises an identification of an employee associated with the governmental project.

19. A system for managing a governmental project, comprising:
a processor; and
a computer readable storage medium coupled to the processor and comprising instruction for causing the processor to perform the method comprising:
providing an interface for entering data associated with the governmental project according to an identifier of the governmental project and topics associated with the governmental project;
classifying the data entered according to the identifier and the topics based on rules associated with governmental contracting; and
storing the classified data in a repository embodied in a computer readable storage medium.

20. The system of claim 19, wherein providing the interface, comprises:
generating the interface to include forms for entering the identifier and information on the topics.

21. The system of claim 19, further comprising:
a network interface coupled to the processor, wherein the interface is remotely accessible by a user via the network interface.

22. The system of claim 19, wherein the computer readable storage medium comprises further instruction to cause the processor to perform the method comprising:
receiving access information from a user;
authenticating the access information from the user to grant access to the user; and
establishing access rights of the user based on the access information, wherein the access rights define user ability to enter data for the topics.

23. The system of claim 19, wherein the computer readable storage medium comprises further instruction to cause the processor to perform the method comprising:
receiving a request to retrieve stored data for the governmental project;
searching the repository for the stored data matching the request;
generating a report comprising the matching stored data; and
providing the report to an initiator of the request.

24. The system of claim 19, wherein the computer readable storage medium comprises further instruction to cause the processor to perform the method comprising:
providing an administrator interface, the administrator interface comprising forms for receiving access information of users and access rights associated with the users; and
storing the access information and access rights associated with the users.

25. The system of claim 19, wherein storing the classified data comprises:
storing the classified data in tables of a database, wherein each table is associated with one of the topics.

26. The system of claim 19, wherein the topics comprise at least one of deliverables, metrics, work performed, staffing and risks.

27. The system of claim 19, wherein the identifier of the governmental project further comprises an identification of an employee associated with the governmental project.
